(19) United States
(12) Patent Application Publication
(10) Pub. No.: US 2021/0058784 A1
(43) Pub. Date: Feb. 25, 2021

(54) USER EQUIPMENT ONBOARDING BASED ON DEFAULT MANUFACTURER CREDENTIALS UNLICENSED

(71) Applicant: Intel Corporation, Santa Clara, CA (US)

(72) Inventors: Meghashree Dattatri Kedalagudde, Portland, OR (US); Alexandre Saso Stojanovski, Paris (FR); Abhijeet Kolekar, Hillsboro, OR (US)

(21) Appl. No.: 17/091,935

(22) Filed: Nov. 6, 2020

Related U.S. Application Data
(60) Provisional application No. 62/933,063, filed on Nov. 8, 2019.

(51) Int. Cl. H04W 12/06; H04W 76/12; H04W 48/16; H04W 48/18; H04L 29/06

(52) U.S. Cl. CPC H04W 12/06; H04W 76/12; H04L 63/08; H04W 48/18; H04W 48/16

(57) ABSTRACT

Disclosed embodiments are related to user equipment (UE) onboarding and remote provisioning for non-public networks (NPNs). The embodiments allow UEs to get network connectivity to an onboarding server and/or onboarding NPN so that the UEs can be provisioned with subscription credentials and configuration information for establishing connectivity with the NPN. Other embodiments may be described and/or claimed.

### CROSS REFERENCE TO RELATED APPLICATION

The present application claims priority to U.S. Provisional App. No. 62/933,063, which was filed Nov. 8, 2019, the contents of which is hereby incorporated by reference in its entirety.

### FIELD

Embodiments relate generally to the technical field of wireless communications and communication networks, and in particular to service and feature requirements applicable to mobile and fixed communications technology requirements for non-public networks.

### BACKGROUND

A Non-Public Network (NPN) is a Fifth Generation System (5GS) deployed for non-public use. An NPN may be deployed as a Stand-alone Non-Public Network (SNPN) or a Public network integrated NPN (PNI-NPN). An SNPN is operated by an NPN operator and not relying on network functions provided by a Public Land Mobile Network (PLMN). A PNI-NPN is a non-public network deployed with the support of a PLMN. The system architecture and solutions to support UE onboarding and provisioning for NPNs have not yet been defined or developed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1 and 2 illustrate example UE onboarding and provisioning for NPN architectures according to various embodiments. FIGS. 3 and 4 illustrate example procedures for practicing various embodiments discussed herein. FIG. 8 illustrates an example architecture for UE Onboarding to an Subscription Owner Stand-alone Non-Public Network according to various embodiments.

FIG. 5 illustrates an example network architecture according to various embodiments. FIGS. 6 and 7 illustrate example core network architectures according to various embodiments. FIG. 9 illustrates an example of infrastructure equipment in accordance with various embodiments. FIG. 10 schematically illustrates a wireless network in accordance with various embodiments. FIG. 11 is a block diagram illustrating components, according to some example embodiments, able to read instructions from a machine-readable or computer-readable medium (e.g., a non-transitory machine-readable storage medium) and perform any one or more of the methodologies discussed herein. FIGS. 12, 13, and 14 illustrate example procedures for practicing various embodiments discussed herein.

### DETAILED DESCRIPTION

The present disclosure provides system architecture embodiments and mechanisms to support UE onboarding and provisioning for NPNs. In particular, embodiments herein addresses the following NPN-related issues: (1) based on operator policy, the 5G system (5GS) should support a mechanism to provision on-demand connectivity (e.g., IP connectivity for remote provisioning); and (2) the 5GS should support a secure mechanism for a network operator of an NPN to remotely provision the non-3GPP identities and credentials of a uniquely identifiable and verifiably secure Internet of Things (IoT) device. Embodiments herein include for UE onboarding mechanisms based on default manufacturer credentials.

According to various embodiments, the architecture and mechanisms to support UE onboarding and provisioning for NPNs include: means for a UE, that is verifiably secure and uniquely identifiable to 5GS, for onboarding and remote provisioning; and support of exposure via APIs to support UE onboarding and remote provisioning, if required.

Specific aspects for component 1 (e.g., UE onboarding to enable 3GPP connectivity) may include: mechanisms for a UE to discover and select the onboarding SNPN before UE NPN credentials and other information to enable UE to get 3GPP connectivity are provisioned; how and whether the onboarding SNPN authenticates the UE, and establishes a secure 3GPP connectivity, before the UE's NPN credentials and other information to enable SNPN access are provisioned; how to establish a secure connectivity between the UE and the network entity for provisioning the NPN credentials and other information to enable SNPN access (e.g., how to enable ciphering and integrity protection of the connection and the authentication of UE at the Provisioning Server); and how does the 5GS provide and update in the network the subscription of an authorized UE in order to allow the UE to request connectivity to a desired SNPN.

Additionally, specific architectural aspects may include which NFs are involved, and which scenario(s) the solution is addressing, including: which network entity performs UE's subscription provisioning and where is the network entity located. If the network entity performing UE subscription provisioning is external to the SNPN, what is the service-based interface exposed by the SNPN towards that network entity for UE onboarding and provisioning.

Specific aspects for component 2 (e.g., remote provisioning of credentials to allow access to NPN services) may include: SNPN case: provisioning of NPN credentials (e.g., for primary authentication) and other information to enable SNPN access; PNI-NPN case: provisioning of NPN credentials for access to specific slice(s) and/or PDU Sessions offering NPN services (e.g., for Network Slice Specific Authentication and Authorization and/or secondary authentication for PDU Sessions); means to remotely provision the required new or updated information to the UE for enabling the UE to access the NPN using 5GS, including, for example: triggers and procedures used to initiate the provisioning procedure; how the network entity provisions the NPN credentials to the UE.

### 1. Non-Public Network (NPN) Aspects

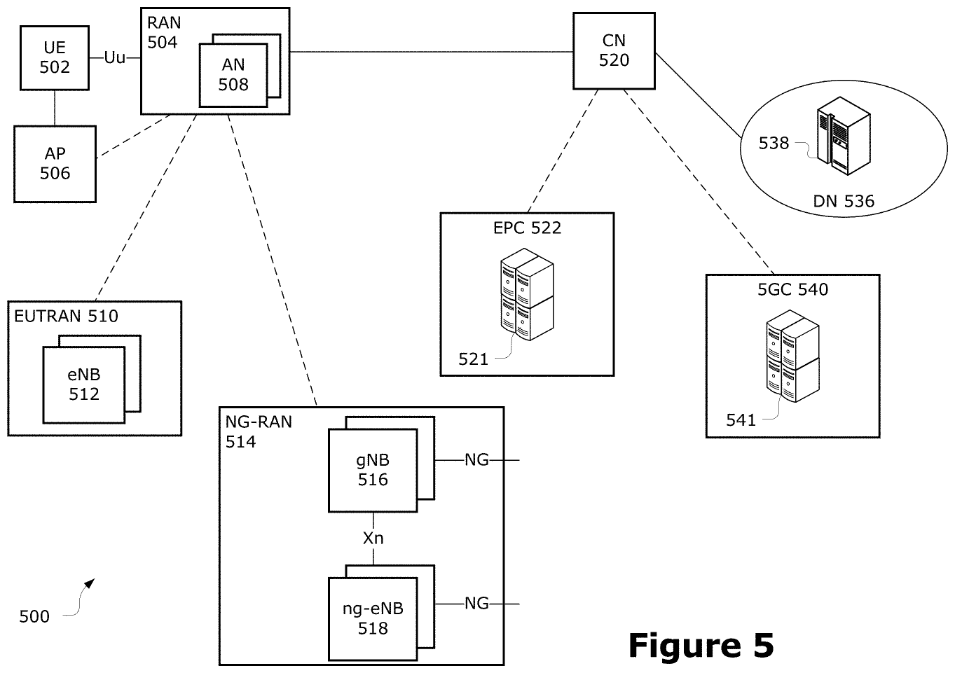

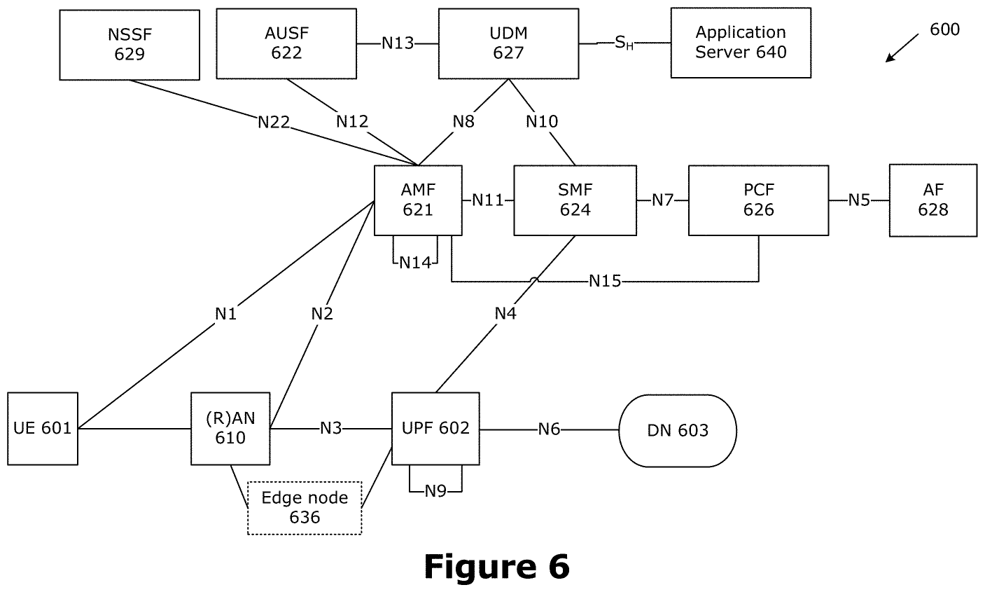

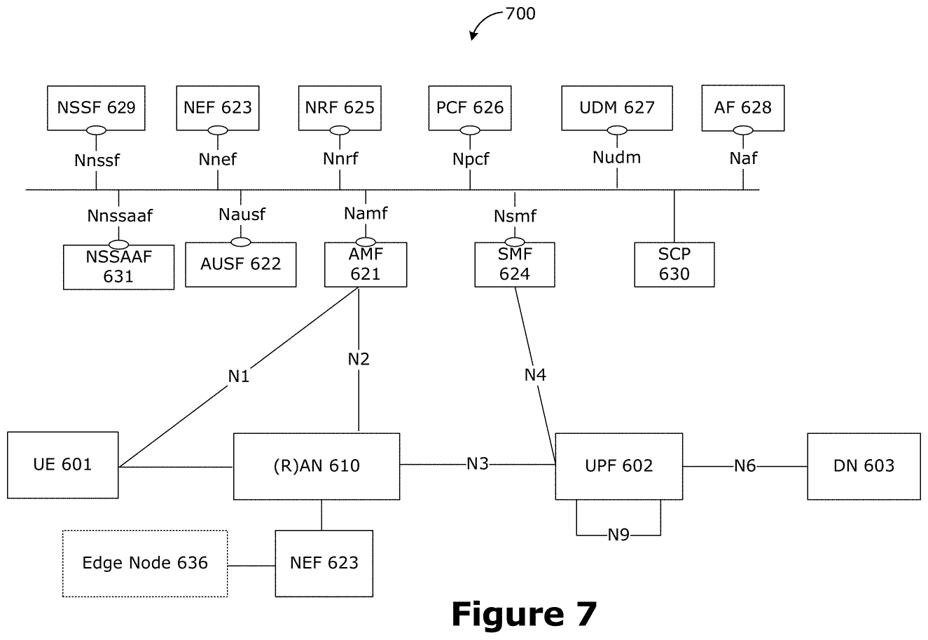

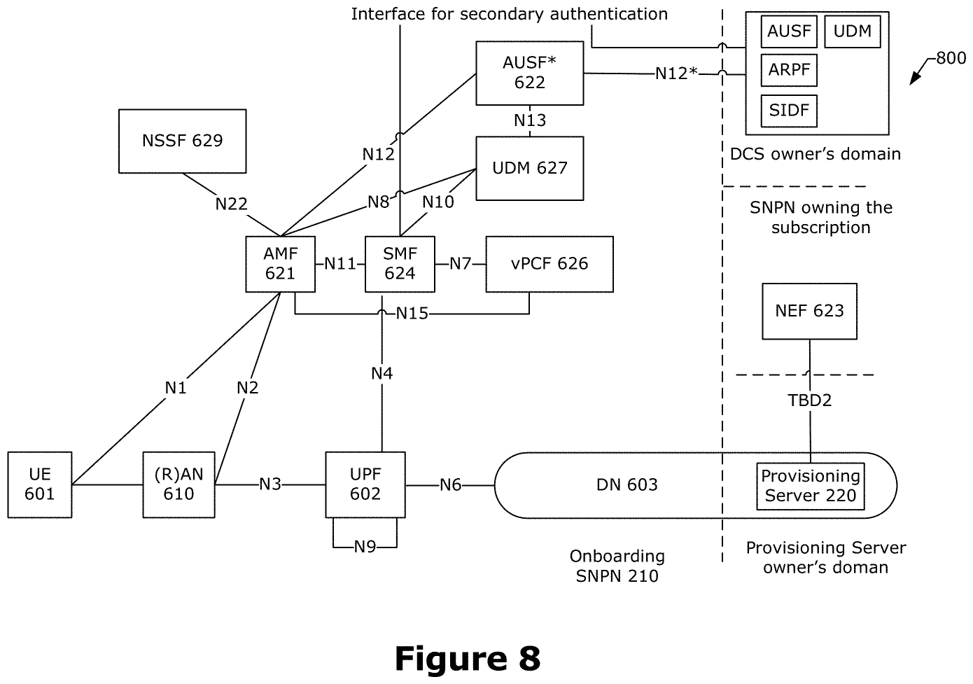

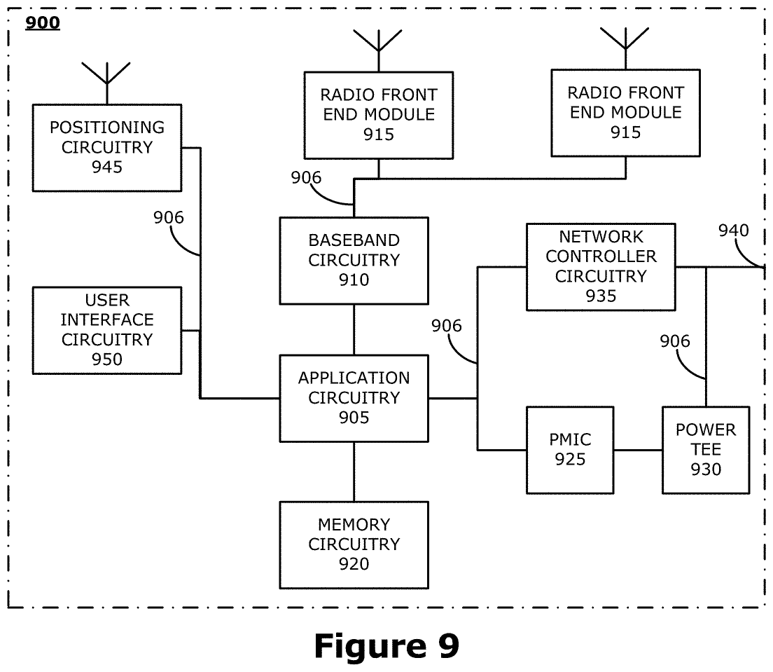

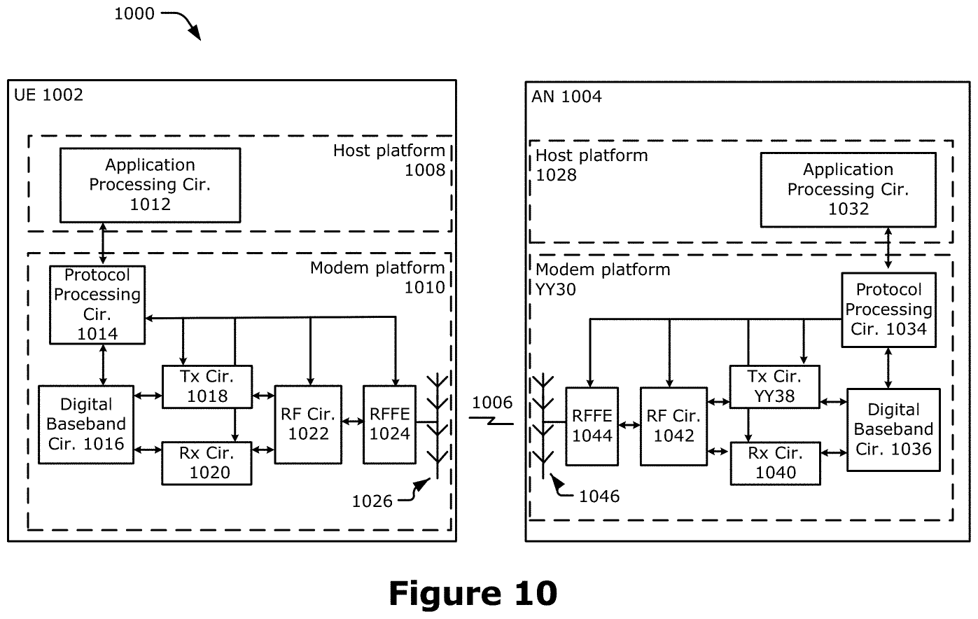

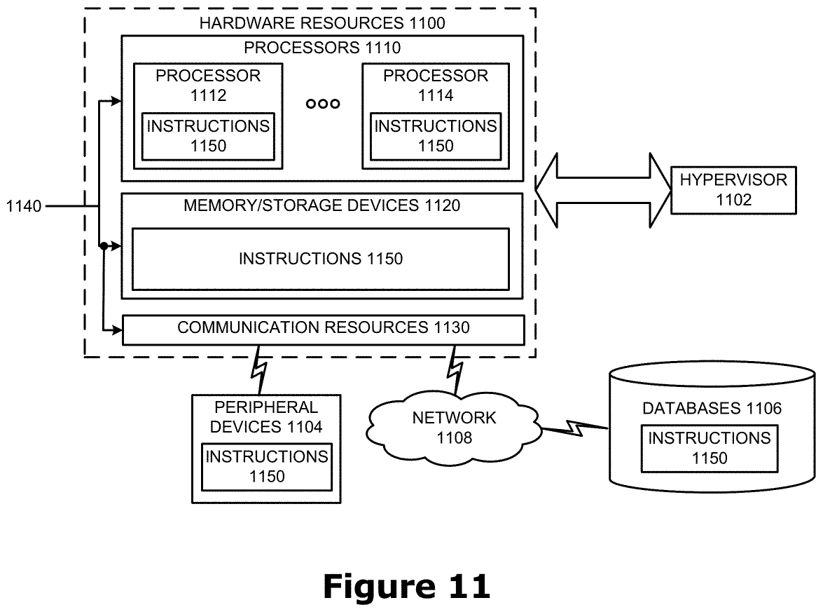

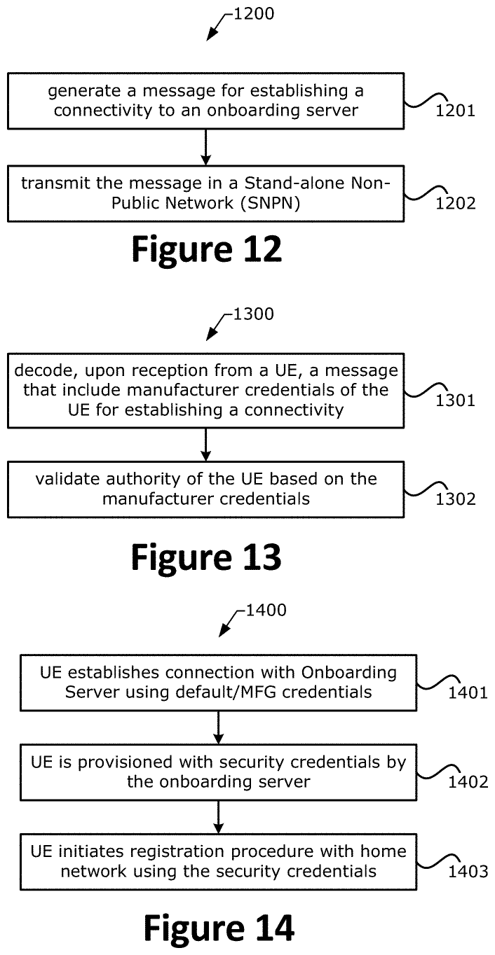

A Non-Public Network (NPN) is a 5GS deployed for non-public use (see e.g., 3GPP TS 22.261 v17.0.1 (2019-10-03) (“[T522261]”). An NPN is either a Stand-alone Non-Public Network (SNPN) or a Public Network Integrated NPN (PNI-NPN). An SNPN is operated by an NPN operator and does not rely on network functions provided by a PLMN. A PNI-NPN is a non-public network deployed with the support of a PLMN. An NPN and a PLMN can share NG-RAN (e.g., NG-RAN 514 in FIG. 5) as described in clause 5.18 of 3GPP TS 23.501 v16.2.0 (2019 Sep. 24) (“[T523501]”). SNPNs are described in clause 5.30.2 of [TS23501] and PNI-NPN are described in clause 5.30.3 of [T523501].

1.1. Stand-Alone Non-Public Networks (SNPN)

SNPN 5GS deployments are based on the architecture depicted in FIG. 7 and/or depicted in clause 4.2.3 of [TS23501], the architecture for 5GC with untrusted non-3GPP access (FIG. 4.2.8.2.1-1 of [T523501]) for access to SNPN services via a PLMN (and vice versa) and the additional functionality covered in clause 5.30.2 of [T523501].

Interworking with EPS is not supported for SNPN. Also, emergency services are not supported for SNPN. Furthermore, roaming is not supported for SNPN (e.g., roaming between SNPNs). Handover between SNPNs, between SNPN and PLMN or PNI NPN are not supported. CIoT 5GS optimizations are not supported in SNPNs.

1.1.1. Identifiers

The combination of a PLMN identifier (ID) and Network identifier (NID) identifies an SNPN (e.g., as a subscriber identifier (SUPI)). The PLMN ID used for SNPNs is not required to be unique. PLMN IDs reserved for use by private networks can be used for non-public networks (e.g., based on mobile country code (MCC) 999 as assigned by ITU). Alternatively, a PLMN operator can use its own PLMN IDs for SNPN(s) along with NID(s), but registration in a PLMN and mobility between a PLMN and an SNPN are not supported using an SNPN subscription given that the SNPNs are not relying on network functions provided by the PLMN.

The NID supports two assignment models: self-assignment and coordinated assignment. Self-assignment involves NIDs being chosen individually by SNPNs at deployment time (and may therefore not be unique) but use a different numbering space than the coordinated assignment NIDs as defined in 3GPP TS 23.003 v15.8.0 (2019 Sep. 18) (“[T523003]”). Coordinated assignment involves NIDs being assigned using one of the following two options: (1) the NID is assigned such that it is globally unique independent of the PLMN ID used; or (2) the NID is assigned such that the combination of the NID and the PLMN ID is globally unique.

An optional human-readable network name may be used to help identify an SNPN during manual SNPN selection. The human-readable network name and how it is used for SNPN manual selection is specified in [T522261] and 3GPP TS 23.122 (2019 Sep. 24) (“[T523122]”).

1.1.2. Broadcast System Information

NG-RAN nodes (e.g., gNB 516 or ng-eNB 518 of FIG. 5) which provide access to SNPNs broadcast the following information: one or multiple PLMN IDs; list of NIDs per PLMN ID identifying the non-public networks NG-RAN provides access to; and/or a human-readable network name per NID. In some implementations, the NG-RAN node supports broadcasting a total of twelve NIDs. Further details are defined in 3GPP TS 38.331 v15.7.0 (2019 Sep. 27) (“[T538331]”). The presence of a list of NIDs for a PLMN ID indicates that the related PLMN ID and NIDs identify SNPNs. The human-readable network name per NID is only used for manual SNPN selection. The mechanism how human-readable network name is provided (e.g., whether it is broadcasted or unicasted) to the UE (e.g., UE 502 of FIG. 5) is specified in [T538331]. Optionally information, as described in TS 38.300 v15.7.0 (2019 Sep. 26) (“[T538300]”), [T538331] and in 3GPP TS 38.304 v15.5.0 (2019 Sep. 28) (“[T538304]”), to prevent UEs not supporting SNPNs from accessing the cell (e.g., if the cell only provides access to non-public networks).

1.1.3. UE Configuration and Subscription Aspects

An SNPN-enabled UE (e.g., UE 502 of FIG. 5) is configured with subscriber identifier (SUPI) and credentials for each subscribed SNPN identified by the combination of PLMN ID and NID. A subscriber of an SNPN is either: identified by a SUPI containing a network-specific identifier that takes the form of a Network Access Identifier (NAI) using the NAI RFC 7542 based user identification as defined in [T523003] clause 28.7.2 (the realm part of the NAI may include the NID of the SNPN; or identified by a SUPI containing an IMSI.

An SNPN-enabled UE 502 supports the SNPN access mode. When the UE 502 is set to operate in SNPN access mode the UE 502 only selects and registers with SNPNs over Uu as described in clause 5.30.2.4 of [T523501].

If the UE 502 is not set to operate in SNPN access mode, even if it is SNPN-enabled, the UE does not select and register with SNPNs. A UE 502 not set to operate in SNPN access mode performs PLMN selection procedures as defined in clause 4.4 of [T523122]. For a UE 502 capable of simultaneously connecting to an SNPN and a PLMN, the setting for operation in SNPN access mode is applied only to the Uu interface for connection to the SNPN. Annex D.4 of [T523501] provides more details. Details of activation and deactivation of SNPN access mode are up to UE 502 implementation.

1.1.4. Network Selection in SNPN Access Mode

When a UE 502 is set to operate in SNPN access mode the UE 502 does not perform normal PLMN selection procedures as defined in clause 4.4 of [T523122]. UEs 502 operating in SNPN access mode read the available PLMN IDs and list of available NIDs from the broadcast system information and take them into account during network selection.

For automatic network selection, the UE 502 selects and attempts to register with the available SNPN identified by a PLMN ID and NID for which the UE 502 has SUPI and credentials. If multiple SNPNs are available that the UE 502 has respective SUPI and credentials for, then how the UE selects an SNPN is based on UE implementation.

For manual network selection UEs 502 operating in SNPN access mode provide to the user the list of SNPNs (each is identified by a PLMN ID and NID) and related human-readable names (if available) of the available SNPNs the UE 502 has respective SUPI and credentials for. The details of SNPN selection is defined in [T523122].

When a UE 502 performs Initial Registration to an SNPN, the UE 502 indicates the selected NID and the corresponding PLMN ID to the NG-RAN 514. The NG-RAN 514 informs the AMF 621 of the selected PLMN ID and NID.

1.1.5. Network Access Control

If a UE 502 performs the registration or service request procedure in an SNPN identified by a PLMN ID and a self-assigned NID and there is no subscription for the UE 502, then the AMF 621 rejects the UE 502 with an appropriate cause code to temporarily prevent the UE 502 from automatically selecting and registering with the same SNPN. If a UE 502 performs the registration or service request procedure in an SNPN identified by a PLMN ID and a coordinated assigned NID and there is no subscription for the UE 502, then the AMF 621 rejects the UE 502 with an appropriate cause code to permanently prevent the UE 502 from automatically selecting and registering with the same SNPN. The details of rejection and cause codes is defined in 3GPP TS 24.501 v16.2.0 (2019 Sep. 24) (“[T524501]”).

In order to prevent access to SNPNs for authorized UE(s) in the case of network congestion/overload, Unified Access Control information is configured per SNPN (e.g., as part of the subscription information that the UE 502 has for a given SNPN) and provided to the UE 502 as described in [T524501].

1.1.6. Cell (Re-)Selection in SNPN Access Mode

UEs 502 operating in SNPN access mode only select cells and networks broadcasting both PLMN ID and NID of the selected SNPN. Further details on the NR idle and inactive mode procedures for SNPN cell selection is defined in [T538331] and in [T538304].

1.1.7. Access to PLMN Services Via Stand-Alone Non-Public Networks

To access PLMN services, a UE 502 in SNPN access mode that has successfully registered with an SNPN may perform another registration via the SNPN User Plane with a PLMN (using the credentials of that PLMN) following the same architectural principles as specified in clause 4.2.8 (including the optional support for PDU Session continuity between PLMN and SNPN using the Handover of a PDU Session procedures in 3GPP TS 23.502 v16.2.0 (2019 Sep. 24) (“[T523502]”) clauses 4.9.2.1 and 4.9.2.2) and the SNPN taking the role of “Untrusted non-3GPP access”. Annex D, clause D.3 of [T523501] provides additional details.

NOTE: QoS differentiation in the SNPN can be provided on per-IPsec Child Security Association basis by using the UE 502 or network requested PDU Session Modification procedure described in [T523502] clause 4.3.3.2. In the PLMN, N3IWF determines the IPsec child SAs as defined in [T523502] clause 4.12. The N3IWF is preconfigured by PLMN to allocate different IPsec child SAs for QoS Flows with different QoS profiles.

To support QoS differentiation in the SNPN with network-initiated QoS, the mapping rules between the SNPN and the PLMN are assumed to be governed by an SLA including: 1) mapping between the differentiated services code point (DSCP) markings for the IPsec child SAs on NWu and the corresponding QoS, which is the QoS requirement of the PLMN and is expected to be provided by the SNPN, and 2) N3IWF IP address(es) in the PLMN. The non-alteration of the DSCP field on NWu is also assumed to be governed by an SLA and by transport-level arrangements that are outside of 3GPP scope. The packet detection filters in the SNPN can be based on the N3IWF IP address and the DSCP markings on NWu.

To support QoS differentiation in the SNPN with UE-requested QoS, the UE 502 can request for an IPsec SA the same 5QI from the SNPN as the 5QI provided by the PLMN. It is assumed that UE-requested QoS is used only when the 5QIs used by the PLMN are from the range of standardized 5QIs. The packet filters in the requested QoS rule can be based on the N3IWF IP address and the SPI associated with the IPsec SA.

1.1.8. Access to Stand-Alone Non-Public Network Services Via PLMN

To access SNPN services, a UE 502 that has successfully registered with a PLMN over 3GPP access may perform another registration via the PLMN User Plane with an SNPN (using the credentials of that SNPN) following the same architectural principles as specified in clause 4.2.8 (including the optional support for PDU Session continuity between PLMN and SNPN using the Handover of a PDU Session procedures in [T523502] clauses 4.9.2.1 and 4.9.2.2) and the PLMN taking the role of “Untrusted non-3GPP access” of the SNPN, e.g., using the procedures for Untrusted non-3GPP access in clause 4.12.2 of [T523502]. Annex D, clause D.3 of [T523501] provides additional details. The case where UE 502 that has successfully registered with a PLMN over non-3GPP access to access SNPN services is not specified in this Release.

NOTE: QoS differentiation in the PLMN can be provided on per-IPsec Child Security Association basis by using the UE 502 or network requested PDU Session Modification procedure described in [T523502] clause 4.3.3.2. In the SNPN, N3IWF determines the IPsec child SAs as defined in [T523502] clause 4.12. The N3IWF is preconfigured by SNPN to allocate different IPsec child SAs for QoS Flows with different QoS profiles.

To support QoS differentiation in the PLMN with network-initiated QoS, the mapping rules between the PLMN and the SNPN are assumed to be governed by an SLA including: 1) mapping between the DSCP markings for the IPsec child SAs on NWu and the corresponding QoS, which is the QoS requirement of the SNPN and is expected to be provided by the PLMN, and 2) N3IWF IP address(es) in the SNPN. The non-alteration of the DSCP field on NWu is also assumed to be governed by an SLA and by transport-level arrangements that are outside of 3GPP scope. The packet detection filters in the PLMN can be based on the N3IWF IP address and the DSCP markings on NWu.

To support QoS differentiation in the PLMN with UE-requested QoS, the UE 502 can request for an IPsec SA the same 5QI from the PLMN as the 5QI provided by the SNPN. It is assumed that UE-requested QoS is used only when the 5QIs used by the SNPN are from the range of standardized 5QIs. The packet filters in the requested QoS rule can be based on the N3IWF IP address and the SPI associated with the IPsec SA.

1.2. Public Network Integrated NPN (PNI-NPN)

Public Network Integrated NPNs are NPNs made available via PLMNs e.g., by means of dedicated DNNs, or by one (or more) Network Slice instances allocated for the NPN. The existing network slicing functionalities apply as described in clause 5.15. When a PNI-NPN is made available via a PLMN, then the UE 502 has a subscription for the PLMN in order to access PNI-NPN. Annex D of [T523501] provides additional consideration to consider when supporting Non-Public Network as a Network Slice of a PLMN.

As network slicing does not enable the possibility to prevent UEs 502 from trying to access the network in areas where the UE 502 is not allowed to use the Network Slice allocated for the NPN, Closed Access Groups (CAGs) may optionally be used to apply access control. A CAG identifies a group of subscribers who are permitted to access one or more CAG cells associated to the CAG. A CAG is used for the PNI-NPNs to prevent UE(s) 502, which are not allowed to access the NPN via the associated cell(s), from automatically selecting and accessing the associated CAG cell(s). CAGs are used for access control, for example, authorization at cell selection and configured in the subscription as part of the Mobility Restrictions e.g., independent from any S-NSSAI. CAG is not used as input to AMF selection nor Network Slice selection. If NPN isolation is desired, operator can better support NPN isolation by deploying network slicing for PNI-NPN, configuring dedicated S-NSSAI(s) for the given NPN as specified in Annex D, clause D.2 of [T523501], and restricting NPN's UE 502 subscriptions to these dedicated S-NSSAI(s).

1.2.1. Identifiers

The following may be required for identification: a CAG is identified by a CAG Identifier which is unique within the scope of a PLMN ID; a CAG cell broadcasts one or multiple CAG Identifiers per PLMN; and a CAG cell may in addition broadcast a human-readable network name per CAG Identifier. The human-readable network name per CAG Identifier is only used for presentation to user when user requests a manual CAG selection. In some implementations, a cell supports broadcasting a total of twelve CAG Identifiers. Further details are defined in [T538331].

1.2.2. UE Configuration, Subscription Aspects and Storage

To use CAG, the UE, that supports CAG as indicated as part of the UE 5GMM Core Network Capability (see e.g., clause 5.4.4a of [T523501]), may be pre-configured or (re)configured with the following CAG information, included in the subscription as part of the Mobility Restrictions: an Allowed CAG list e.g., a list of CAG Identifiers the UE 502 is allowed to access; and optionally, a CAG-only indication whether the UE 502 is only allowed to access 5GS via CAG cells (see [T538304] for how the UE 502 identifies whether a cell is a CAG cell); and the HPLMN may configure or re-configure a UE 502 with the above CAG information using the UE 502 Configuration Update procedure for access and mobility management related parameters described in [T523502] in clause 4.2.4.2. The aforementioned CAG information is provided by the HPLMN on a per PLMN basis. In a PLMN the UE 502 only considers the CAG information provided for this PLMN.

When the subscribed CAG information changes, UDM 627 sets a CAG information Subscription Change Indication and sends it to the AMF 621. The AMF 621 provides the UE 502 with the CAG information when the UDM 627 indicates that the CAG information within the Access and Mobility Subscription data has been changed. When the AMF 621 receives the indication from the UDM 627 that the CAG information within the Access and Mobility Subscription has changed, the AMF 621 uses the CAG information received from the UDM 627 to update the UE. Once the AMF 621 updates the UE 502 and obtains an acknowledgment from the UE 502, the AMF 621 informs the UDM 627 that the update was successful and the UDM 627 clears the CAG information Subscription Change Indication flag.

The AMF 621 may update the UE 502 using either the UE 502 Configuration Update procedure after registration procedure is completed, or by including the new CAG information in the Registration Accept or in the Registration Reject.

When the UE 502 is roaming and the Serving PLMN provides CAG information, the UE 502 updates only the CAG information provided for the Serving PLMN while the stored CAG information for other PLMNs are not updated. When the UE 502 is not roaming and the HPLMN provides CAG information, the UE 502 updates the CAG information stored in the UE 502 with the received CAG information for all the PLMNs.

The UE 502 stores the latest available CAG information for every PLMN for which it is provided and keep it stored when the UE 502 is de-registered or switched off, as described in [T524501]. In various implementations, the CAG information has no implication on whether and how the UE 502 accesses 5GS over non-3GPP access.

1.2.3. Network and Cell (Re-)Selection, and Access Control

The following may be assumed for network and cell selection, and access control: the CAG cell broadcasts information such that only UEs supporting CAG are accessing the cell (see [T538300], [T538304]). This may imply that cells are either CAG cells or normal PLMN cells. For network sharing scenario between SNPN, PNI-NPN and PLMNs (see e.g., clause 5.18 of [T523501]). In order to prevent access to NPNs for authorized UE(s) 502 in the case of network congestion/overload, existing mechanisms defined for Control Plane load control, congestion and overload control in clause 5.19 of [T523501] can be used, as well as the access control and barring functionality described in clause 5.2.5 of [T523501], or Unified Access Control using the access categories as defined in [T524501] can be used.

Aspects of automatic and manual network selection in relation to CAG are discussed in [T523122]. Aspects related to cell (re-)selection are discussed in [T538304]. The Mobility Restrictions are able to restrict the UE's 502 mobility according to the Allowed CAG list (if configured in the subscription) and include an indication whether the UE 502 is only allowed to access CAG cells (if configured in the subscription).

During transition from CM-IDLE to CM-CONNECTED, if the UE 502 is accessing the 5GS via a CAG cell: The AMF 621 verifies whether UE 502 access is allowed by Mobility Restrictions: It is assumed that the AMF 621 is made aware of the supported CAG Identifier(s) of the CAG cell by the NG-RAN 514. If at least one of the CAG Identifier(s) received from the NG-RAN 514 is part of the UE's 502 Allowed CAG list, then the AMF 621 accepts the NAS request; if none of the CAG Identifier(s) received from the NG-RAN 514 are part of the UE's 502 Allowed CAG list, then the AMF 621 rejects the NAS request and the AMF 621 should include CAG information in the NAS reject message. The AMF 621 then releases the NAS signalling connection for the UE 502 by triggering the AN release procedure; and if the UE 502 is accessing the network via a non-CAG cell and the UE's 502 subscription contains an indication that the UE 502 is only allowed to access CAG cells, then the AMF 621 rejects the NAS request and the AMF 621 should include CAG information in the NAS reject message. The AMF 621 then releases the NAS signalling connection for the UE 502 by triggering the AN release procedure.

During transition from RRC Inactive to RRC Connected state: when the UE 502 initiates the RRC Resume procedure for RRC Inactive to RRC Connected state transition in a CAG cell, NG-RAN 514 rejects the RRC Resume request from the UE 502 if none of the CAG Identifiers supported by the CAG cell are part of the UE's 502 Allowed CAG list according to the Mobility Restrictions received from the AMF 621. When the UE 502 initiates the RRC Resume procedure for RRC Inactive to RRC Connected state transition in a non-CAG cell, NG-RAN 514 rejects the UE's 502 Resume request if the UE 502 is only allowed to access CAG cells according to the Mobility Restrictions received from the AMF 621.

During connected mode mobility procedures: Based on the Mobility Restrictions received from the AMF 621: source NG-RAN 514 does not handover the UE 502 to a target NG-RAN node 516/518 if the target is a CAG cell and none of the CAG Identifiers supported by the CAG cell are part of the UE's 502 Allowed CAG list; source NG-RAN 514 does not handover the UE 502 to a non-CAG cell if the UE 502 is only allowed to access CAG cells; if the target cell is a CAG cell, target NG-RAN 514 rejects the N2 based handover procedure if none of the CAG Identifiers supported by the CAG cell are part of the UE's 502 Allowed CAG list in the Mobility Restriction List; if the target cell is a non-CAG cell, target NG-RAN 514 rejects the N2 based handover procedure if the UE 502 is only allowed to access CAG cells based on the Mobility Restriction List.

Update of Mobility Restrictions: when the AMF 621 receives the Nudm_SDM_Notification from the UDM 627 and the AMF 621 determines that the Allowed CAG list or the indication whether the UE 502 is only allowed to access CAG cells have changed; the AMF 621 updates the Mobility Restrictions in the UE 502 and NG-RAN 514 accordingly under the conditions as described in [T523502] clause 4.2.4.2. When the UE 502 is accessing the network for emergency service the conditions for AMF 621 discussed in [T523501], clause 5.16.4.3 apply.

1.2.4. Support of Emergency Services in CAG Cells

Emergency Services are supported in CAG cells, for UEs supporting CAG, whether normally registered or emergency registered as described in [T523501] clause 5.16.4 and [T523502] clause 4.13.4. A UE 502 may camp on an acceptable CAG cell in limited service state as specified in [T523122] and [T538304], based on operator policy defined in [T538300].

For UEs not supporting CAG, but are emergency registered as described in clause 5.16.4 and [T523502] clause 4.13.4, Emergency Services may be supported based on operator policy as defined in [T538300]. Support for Emergency services requires each cell with a Cell Identity associated with PLMNs or PNI-NPNs to only be connected to AMFs 621 that supports emergency services.

The UE 502 selects a PLMN (of a CAG cell or non-CAG cell), as described in [T523122] and 3GPP TS 23.167 v16.0.0 (2019 Sep. 24), when initiating emergency services from limited service state.

During handover to a CAG cell, if the UE 502 is not authorized to access the target CAG cell and has emergency services, the target NG-RAN node 516/518 only accepts the emergency PDU sessions and the target AMF 621 releases the non-emergency PDU connections that were not accepted by the NG-RAN node 516/518. Upon completion of handover the UE 502 behave as emergency registered.

### 2. UE Onboarding for NPN Embodiments

The UE onboarding in NPN embodiments herein addresses the aforementioned issues with UE Onboarding and remote provisioning for NPNs, especially when the UEs 502 are deployed without provisioned subscription. The embodiments herein provide a solution on how UE subscription/credentials are afterward provisioned to the UEs 502.

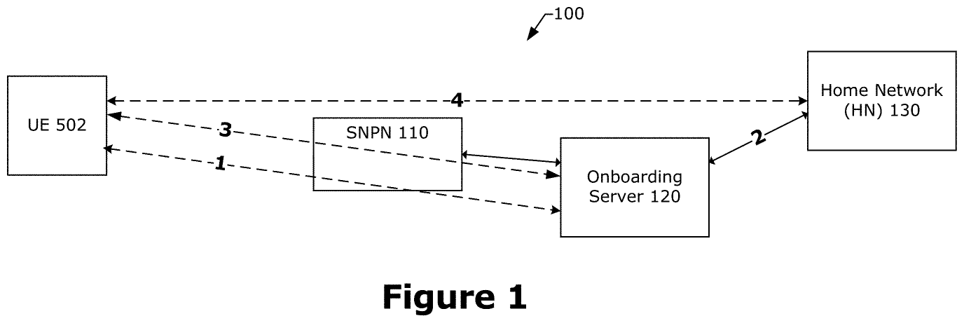

FIG. 1 shows an example UE onboarding and provisioning for NPN architecture 100 according to various embodiments. UE onboarding refers to provisioning of information, to a UE 502 and within a network, required for the UE 502 to get authorized access and connectivity to an NPN. Additionally or alternatively, UE onboarding may refer to provisioning a newly assigned NPN subscription to a UE 502 that has no subscription to a particular NPN. For purposes of the present disclosure, the term “NPN” may refer to an SNPN or a PNI-NPN. The UE onboarding and provisioning architecture 100 includes a UE 502, an SNPN 110, an onboarding server 120, and a home network (HN) 130. It should be noted that the SNPN 110 could be a PNI-NPN in other embodiments.

In this example, the UE 502 only has credentials provided by a device manufacturer (MFG), which may be referred to as “manufacturer credentials” or “MFG credentials.” The MFG credentials may be “default UE credentials,” which is/are information that the UE 502 has before the actual onboarding procedure to make it uniquely identifiable and verifiably secure. The UE 502 is not provisioned with credentials required to access either the NPN or the future home network of the UE 502 (hereinafter referred to as “network credentials” or “NPN credentials”). The network/NPN credentials may include information that the UE 502 uses for authentication to access an NPN. NPN credentials may be 3GPP credentials (e.g., SUPI and associated key for Authentication and Key Agreement (AKA)) or non-3GPP credentials. (e.g., user identifier in Network Access Identifier (NAI) format and associated digital certificate).

SNPN 110 supports connectivity from an unauthenticated UE 502 (e.g., a UE 502 with no network credentials) to the onboarding server 120 so that it can be provisioned with network credentials of the HN 130. In a majority of cases, the SNPN 110 and HN 130 will be the same network, but in certain scenarios the SNPN may be different from the HN 130. In the general case depicted in figure the SNPN and the HN 130 are considered as separate networks.

The onboarding server 120 is maintained by the device MFG (or an entity affiliated with the MFG) for provisioning the UE 502 with network/NPN credentials. In some implementations, the onboarding server 120 may be part of an Onboarding Network (ON), which is a network providing initial registration and/or access to the UE 502 for UE Onboarding. Additionally or alternatively, the onboarding server 120 may be, or act as a Provisioning Server, which is a server that provisions an authenticated/authorized UE 502 with subscription data and optionally other configuration information.

The onboarding server 120 plays the role of a verifier. For example, the onboarding server 120 validates the authenticity of the UE 502 based on the MFG credentials assigned to the UE 502 during the manufacturing process which is out of scope of SA2. If UE 502 connectivity to the onboarding server 120 is successfully completed, the onboarding server 120 configures the UE 502 in cooperation with the future home network of the UE 502 with credentials that will allow the UE 502 to register with an NPN while being authenticated by the HN 130. With reference to FIG. 1, a procedure for UE 502 onboarding includes the following steps:

Step 1 involves connectivity to the onboarding server 120 via NPN. Here, the UE 502 with MFG credentials needs to establish connection with the onboarding server 120 for the purpose of provisioning network credentials. The restricted connectivity from UE 502 to the onboarding server 120 is provided by the SNPN 110 based on principles similar to Restricted Local Operator Services (RLOS).

The NG-RAN 514 in the SNPN 110 is configured to broadcast the system information about the support for Restricted Onboarding Services. The UE 502 indicates in the RRC establishment procedure that the connection is for Restricted Onboarding Services based on which the NG-RAN 514 selects the appropriate AMF 621 in the SNPN 110. The AMF 621 selects a designated SMF which in turn selects a designated PDU Session Anchor (PSA) that provides a restricted data connection to the the onboarding server 120.

After connectivity to the the onboarding server 120 is established, the the onboarding server 120 validates the authenticity of the UE 502 based on the MFG credentials following a suitable authentication procedure.

At step 2, agreement to bootstrap HN 130 credentials to the UE 502 is made. At step 3, UE ID and security credentials are provisioned to the UE 502 by the onboarding server 120. In cooperation with the future HN 130, the onboarding server 120 configures the UE 502 with network credentials that will allow the UE 502 to register with an NPN 110 while being authenticated by the HN 130.

At step 4, registration with the future HN 130 of the UE 502 takes place. Based on the HN 130 credentials provisioning in Steps 2 and 3, the UE 502 initiates a Registration procedure with the HN 130.

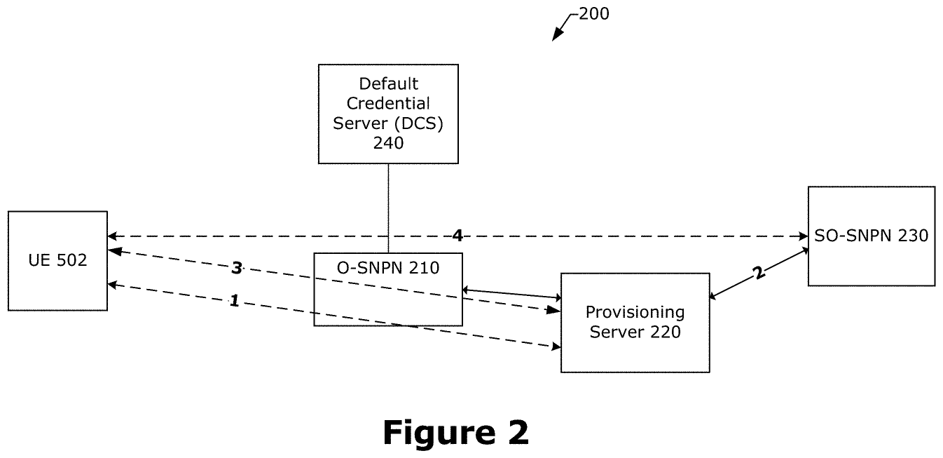

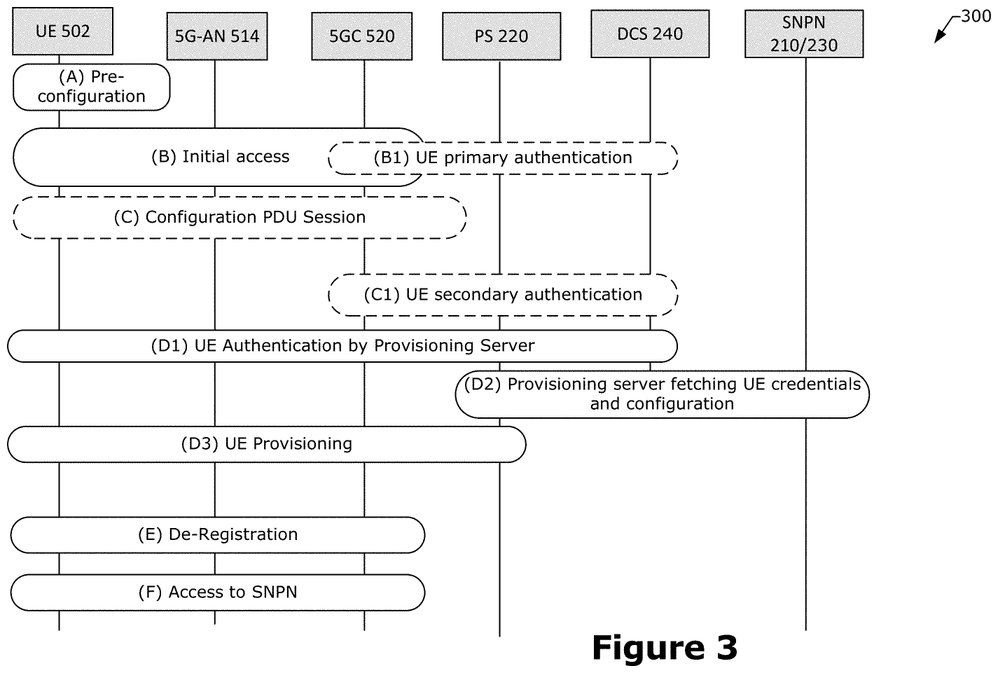

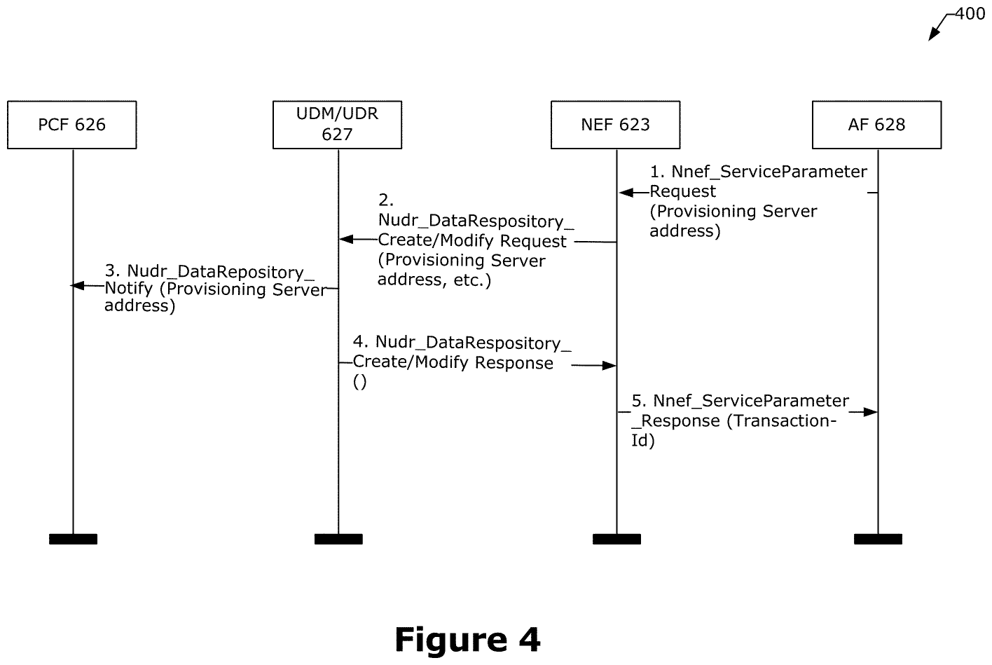

FIG. 2 shows another UE onboarding in NPN architecture 200 according to various embodiments. UE onboarding in NPN architecture 200 includes a UE 502, an Onboarding SNPN (O-SNPN) 210, a provisioning server (PS) 220, a Subscription Owner (SO)-SNPN 230, and a Default Credential Server (DCS) 240. In this embodiment, the UE 502 gets network connectivity to an Onboarding SNPN (O-SNPN) 210 so that it can be provisioned with necessary subscription credentials and configuration for the Subscription Owner (SO)-SNPN 230 that will own the UE's 502 subscription (“SNPN owning the subscription”). In some cases, the O-SNPN 210 may correspond to the SNPN 110, the PS 220 may correspond to the onboarding server 120, and the SO-SNPN 230 may correspond to the HN 130.

In this example, the UE 502 is provisioned with some default UE credentials, a unique UE identifier (UUEID), and one or more ON Group IDs. The UUEID is an ID identifying the UE 502 in the network and the Default Credential Server (DCS) 240, and is assigned and configured by the DCS 240. The UUEID is assumed to be unique within the DCS 240. It takes the form of a Network Access Identifier (NAI) which is composed of the user part and the realm part which may identify the domain name of the DCS 240. An ON group is a group of Onboarding Networks, and the ON Group ID is an identifier of an ON group. Additionally, the UE 502 is not provisioned with subscription credentials that grant access to an SO-PLMN or to an SO-SNPN 230. As part of the onboarding process the UE 502 gets access granted to an O-SNPN 210 based on, for example, the default UE credentials. The Subscription Owner (SO) is an entity that stores and as result of the UE Onboarding procedures provide the subscription data and optionally other configuration information via the provisioning server (PS) to the UE 502.

The O-SNPN 210 that is used by the UE 502 in the onboarding process is not necessarily the same as the SO-SNPN 230 for which subscription credentials will be provisioned in the UE 502. The O-SNPN 210 operator has access to a DCS 240, which is used to verify that UE 502 is subject to onboarding based on UE identifier and the associated default UE credentials. The DCS 240 is used for 5GS-level UE authentication/authorization during registration to O-SNPN 210 for onboarding purpose. The owner of the DCS 240 is out of scope of this document and can be inside or outside of the O-SNPN 210 (e.g., DCS 240) can be owned by the device manufacturer, by a PLMN, by a SNPN other than the O-SNPN 210 or by a 3rd party. The DCS 240 has the business relationship with the O-SNPN 210 if the DCS 240 is outside of the O-SNPN 210. The O-SNPN 210 operator provides the UE 502 with connectivity to the PS 220 that allows UEs to retrieve their subscription credentials and other personalized configuration. The owner of the PS 220 is out of scope of this document.

In some deployments the DCS 240 and the PS 220 can be the same entity. In deployments where the DCS 240 and the PS 220 are different entities, it is expected that they communicate with each other to share the security based on the default UE credentials for UE authentication in the PS 220 via an interface that is outside of 3GPP scope. In some implementations, the DCS 240 may share the default UE credentials with the PS 220 which is a different entity from the DCS 240.

The SO-SNPN 230 owning the subscription is provisioned to its UDM 627 [UDM/UDR] from the PS 220 the corresponding UE's subscription credentials and provides the PS 220 with the corresponding UE's configuration data to be provisioned using the UE onboarding procedure, where default UE credentials is used to identify the corresponding data to be provisioned to the UE. The DCS 240 makes a contract with the SO-SNPNs 230 owning the subscription for provisioning the subscriptions to the UE 502 and provides the SO-SNPN 230 with the list of UE identifiers. The O-SNPN 210 broadcasts system information including an identity of O-SNPN 210, a Support for Onboarding Indication and optionally a list of ON Group IDs. Selection of O-SNPN 210 in case of multiple O-SNPNs 210 supporting UE Onboarding for the UE 502 is up to UE 502 implementation.

With reference to FIG. 2, a procedure for UE 502 onboarding includes the following steps: Step 1, involves connectivity to a PS 220 via the O-SNPN 210. Step 2 involves an agreement to bootstrap SNPN credentials to the UE 502 occuring. Step 3, Subscription Credentials being provisioned to the UE 502 by the PS 220. Step 4, registration with the SO-SNPN 230. This procedure allows the UE 502, which is not initially provisioned with subscription credentials to access an O-SNPN 210 and to obtain subscription credentials and configuration for an SO-SNPN 230 which can be the same as or different from the O-SNPN 210.

The UE 502 selects the O-SNPN 210 based on information broadcasted by the O-SNPN 210 and registers to it for onboarding service to obtain connectivity to the PS 220. If the UE 502 is not configured with network selection parameters for O-SNPN 210, the O-SNPN 210 may be manually selected, or the UE 502 may randomly select a network that's available and supports onboarding functionalities. If the UE 502 fails to complete the remote provisioning through the selected O-SNPN 210 (e.g., the UE 502 fails the authentication by the DCS 240), the UE 502 may select another O-SNPN 210 to try the process again. During the registration procedure the O-SNPN 210 may authenticate the UE 502 with the Default Credential Server (DCS 240) to determine whether the UE 502 is a genuine device subject to onboarding and authorized to access a PS 220 via a Configuration PDU Session. Upon establishment of connectivity to the PS 220, the UE 502 is provisioned with the subscription credentials for the SO-SNPN 230 (e.g., SNPN that will own the UE's subscription) and additional configuration data. Then the UE 502 de-registers from the O-SNPN 210, performs a new network selection, and registers the SO-SNPN 230 using the provisioned subscription credentials and configuration data.

FIG. 3 shows an example procedure 300 for onboarding of the UE 502 into an SO-SNPN 230 according to various embodiments. The procedure 300 shows a high-level flow of the actions needed for a successful onboarding of the UE 502 into an SNPN (e.g., an SO-SNPN 230) for which credentials will be provisioned. Procedure 300 includes the following steps/operations:

Step (A)—UE pre-configuration: The UE 502 is provisioned with default UE credentials that allows for successful UE authentication (step B1 or D) and a unique UE identifier. If an agreement was in place between the UE 502 and the SNPN 230, the UE 502 might have been provisioned with some initial default configuration, including PLMN ID and NID of the SNPN 230, S-NSSAI, DNN needed to access the PS 220, and a list of ON Group IDs.

Step (B)—Initial access: The NG-RAN includes an identity of its O-SNPN 210, Support for Onboarding Indication and optionally a list of ON Group IDs. If the UE 502 realizes that UE Onboarding is required to access an SNPN, it either manually or automatically discovers and selects the O-SNPN 210 network according to broadcasted information and configured information in the UE. If multiple networks are broadcasting the “Support for onboarding” indication, then the UE will select a network at random. If the UE 502 identifies that it has no subscription to access the O-SNPN 210, the UE 502 registers to O-SNPN 210 for onboarding indicating that the registration is regardless of UE subscription, and during the registration procedure the UE 502 provides to the network device-specific information e.g., its default UE credential and corresponding identity (SUPI), and the User may also provide the UE 502 with additional information, such as an PS identity and/or SO-SNPN 230 identity. During the registration procedure, the UE 502 provides an RRC indication that can be used by the NG-RAN 514 to select an AMF 621 for onboarding and an indication in the Registration Request indicating that the registration is for restricted onboarding service only. The UE 502 may also provide additional information for selection of the PS and the SO-SNPN 230 owing the subscription, such as a list of identities of SNPNs the UE 502 can hear, the identity of O-SNPN 210, location of the UE, type of the UE, etc.

Step (B1)—the O-SNPN 210 may discover and connect the DCS 240 for the UE 502 by checking the realm part of the unique UE identifier. The O-SNPN 210 authenticates the UE 502 with the DCS 240 and verify whether the UE 502 is allowed to access the O-SNPN 210 for onboarding purposes. If the DCS 240 is outside of the O-SNPN 210, this authentication is anchored in AUSF* 622 inside the O-SNPN 210 in order to achieve isolation from 3rd party owned DCS 240. DCS 240 can fulfil the rest of security functions of ARPF, SDIF, AUSF 622, and UDM 627 (see e.g., FIG. 8). EAP terminates at the DCS 240, Kausf & Kseaf needs to be derived (which is responsibility of AUSF currently) by the DCS 240 and send to the O-SNPN 210. If the authentication is successful, the DCS 240 optionally sends the identity of the selected SO-SNPN 230 and the information (e.g., address of PS, identity of PS, etc) of the selected PS 220 which are selected based on the information sent by the UE 502 in step B. If the DCS 240 selects multiple SO-SNPN 230s, it may send the priority of the SO-SNPN 230s.

If there is an agreement between the DCS 240 and the O-SNPN 210 for providing UE 502 onboarding, the O-SNPN 210 may decide whether the UE 502 is allowed to access the O-SNPN 210 for onboarding purposes by checking the realm part of the unique UE identifier which includes the information of the DCS 240 before sending the UE 502 authentication request to the DCS 240.

Step (C)—configuration PDU session: The O-SNPN 210 sends the information from the DCS 240 in step B1 and also may send a combination of S-NSSAI and DNN for the PDU Session to the selected PS to the UE. The UE 502 establishes a Configuration PDU session. This PDU Session may be established either to a well-known or pre-configured S-NSSAI or DNN, or a combination of S-NSSAI and DNN sent by the UE 502, which is used for provisioning purposes and has limited connectivity capabilities. Based on this information, the AMF 621 selects a designated SMF 624 which in turn selects a designated PSA that provides a data connection restricted only to the PS 220. In the Configuration PDU Session Establishment Request, the UE 502 includes DCS 240 identity and optionally includes PS identity, SO-SNPN 230 identity or both. When SO-SNPN 230 identity is provided by the UE 502, the SMF 624 in the O-SNPN 210 may decide to override the PS identity provided by the UE 502 and send the new PS identity to the UE 502 in the PDU Session Establishment Accept as PCO parameter. The PS identity received in the PDU Session Establishment Accept, overrides any configured PS identity in the device. The PCF may in addition provision URSP rules for the UE 502 that restrict communication only to the PS 220 and/or specific applications. In some implementations, only one configuration PDU session can be established and connectivity of this PDU session is limited (cf. RLOS), so that the UE 502 can only access a PS 220.

Step (C1)—the PDU Session establishment authentication/authorization as described in [T523502] clause 4.3.2.3 is triggered by the SMF 624 during PDU Session establishment with the DCS 240 based on the DCS 240 identity sent from the UE 502 to the SMF 624 in step C.

Step (D1)—the UE 502 discovers the PS 220 using the stored PS identity. At this point the stored PS identity is one of the following: PS identity preconfigured in the UE, or PS identity entered manually by the user, or PS identity received from the O-SNPN 210. If the UE 502 at this point still does not have a stored PS identity, then the UE 502 uses a well-known FQDN to perform PS discovery. The UE 502 provides the PS 220 with the unique UE identifier, the default UE credentials, optionally the identity of the selected SO-SNPN 230, and the priority of the SO-SNPN 230s. Onboarding SNPN may also assist UE 502 in discovery of PS 220 address as defined in clause 6.5.3.2. The PS 220 may discover and connect the DCS 240 using the realm part of the unique UE identity and may authenticate the UE 502 and make a secure connection for provisioning with the UE, based on the default UE credentials out of scope of 3GPP.

Step (D2)—the PS 220 selects the SO-SNPN 230 owning the subscription and contacts the future SO-SNPN 230 owning the subscription to provide the subscription credentials for access to the SNPN owning the subscription, and may retrieve other UE configuration parameters (e.g., PDU session parameters, such as S-NSSAI, DNN, URSPs, QoS rules, and other required parameters to access the SNPN and establish a regular PDU session). The PS 220 selects the SNPN owning the subscription in one of the following ways: (1) If the UE 502 is pre-configured with the identity of the future SNPN, the UE 502 provides this identity to the PS 220; (2) otherwise, the PS 220 determines the future SNPN by comparing the UE identity with a configured onboarding list; (3) based on the information from the UE 502 in step D 1. In scenarios where the UE 502 is not preconfigured with the identity of the future SNPN (e.g., an off-the-shelf UE) and the PS 220 cannot be configured with information about the specific SO-SNPN 230, onboarding can be performed with the assumption that O-SNPN 210 is the same as the SO-SNPN 230, and the PS 220 is owned by the SNPN.

Step (D3)—the PS 220 provisions the UE's subscription credentials for the SO-SNPN 230 and other configuration information into the UE 502 over the secure connection. The provisioning procedure (step D3) is out of 3GPP scope, where e.g., provisioning protocols of GSMA RSP may be used with some modification considering SNPN architecture than PLMN.

Step (E)—de-registration: Upon a successful provisioning in the previous step, the UE 502 releases the Configuration PDU Session and deregisters from the O-SNPN 210. The UE 502 will then perform SNPN selection and register to the appropriate SNPN as per received configuration and general SNPN selection procedures.

The O-SNPN 210 can monitor the time duration of the Configuration PDU Session or Onboarding Registration in order to prevent misuse. Based on the local configuration policy in the SGC, the network can impose maximum time duration for the Configuration PDU session or Onboarding Registration, upon expiry of which the session is released or the de-registration is triggered. The determination of maximum time duration of the Configuration PDU session is Onboarding Registration is per O-SNPN 210 network configuration.

Step (F)—normal service: Upon a successful de-registration as per step E, the device initiates a regular procedure, including selection of an SO-SNPN 230, Registration using the provisioned credentials with the SO-SNPN 230 owning the subscription, and PDU Session establishment(s). Depending on the provisioned subscription credentials the UE 502 may select an SNPN that is the same or different from the SNPN owning the credentials.

FIG. 4 shows an example procedure 400 for Provisioning Server address(es) configuration using NEF 623 according to various embodiments. To provide Onboarding Services, SNPN is configured with Onboarding Configuration Data in a manner similar to Emergency Configuration Data specified for Emergency Services in [T523501] clause 5.16.4.

The AMF 621 is configured with Onboarding Configuration Data that are applied to Onboarding Services that are established by an AMF 621 based on request from the UE. The AMF Onboarding Configuration Data contains the S-NSSAI and Onboarding DNN which is used to derive an SMF 624. In addition, the AMF Onboarding Configuration Data may contain the statically configured SMF 624 for the Onboarding DNN. The SMF 624 may also store Onboarding Configuration Data that contains statically configured UPF information for the Onboarding DNN. The PCF 626 (and UDR) may store S-NSSAI and Onboarding DNN specific policy information.

Onboarding Configuration Data available to (designated onboarding) PCF 626 and/or SMF 624 includes Provisioning Server (PS) address(es). The Default Credential Server (DCS 240) address may or may not be part of Onboarding Configuration Data.

PS 220 address may be configured within Onboarding Configuration Data locally, as part of authentication signalling with AAA/DCS 240 (FFS) or dynamically by AF 628 via NEF 623 at O-SNPN 210, for instance using Service specific parameter provisioning procedure as specified in [T523502] clause 4.15.6.7, or by using new onboarding specific API to be defined. PS 220 Address may represent address of Local PS (LPS).

In case a UE 502 with a preconfigured Provisioning Server Address receives a Provisioning Server Address from the onboarding network, the Provisioning Server Address received from the onboarding network shall prevail. In case the provisioning process using a network provided Provisioning Server Address fails, the UE 502 reinitiates the provisioning process using the preconfigured Provisioning Server Address. In case this attempt also fails or if the UE 502 does not have a preconfigured Provisioning Server Address the UE 502 detaches from the onboarding network and select another network for onboarding purposes. In some embodiments, an FQDN of the Provisioning Server address(es) is configured to appropriate DNS resolver(s) before Provisioning Server address(es) are configured to O-SNPN 210.

Referring to FIG. 4, the procedure 400 may operate as follows:

At step 1, the AF 628 invokes Nnef_ServiceParameter Request (Provisioning Server address) to the NEF 623. At step 1, an authorized AF 628 invokes NEF 623 at O-SNPN 210 to configure Provisioning Server address(es) for UE 502. The AF 628 provides AF-Service-Identifier. As there is no subscription data for the device within the O-SNPN 210 the UE 502 is identified with Onboarding Identity or Onboarding Group Identity. The Onboarding Identity may be IMEI/PEI, or IMEI/PEI in NAI format. The NEF 623 maps/associates the API request with S-NSSAI and provisioning specific DNN and other information it may have or query from other NFs in O-SNPN 210. Onboarding Service Data includes Service Descriptor and Service Parameters. Service Parameters include Provisioning Server address(es), associated validity timer(s), and geographical area restrictions, data volume restrictions. Onboarding Group Identity may be used to separate the provisioning configuration data from provisioning identity and membership configuration.

At step 2, the NEF 623 invokes Nudr_DataRespository Create/Modify Request (Provisioning Server address, etc.) toward the the UDR (or UDM 627). At step 2, the NEF 623 stores the provisioning information (e.g., provisioning server address(es) etc received via API from AF 628) in the UDR via UDM. It is ffs whether the API request is stored as part application data in UDR.

At step 3, the UDR (or UDM 627) invokes Nudr_DataRepository Notify (Provisioning Server address) toward the PCF(s) 626. At step 3, the UDR (or UDM 627) notifies PCF(s) 626 that have subscribed to changes with data keys mapping to provisioning specific information. The PCF(s) 626 may derive AM and SM specific onboarding policies based on data received from UDR (or UDM 627).

At step 4, the UDR (or UDM 627) invokes Nudr_DataRespository_Create/Modify Response( ) towards the NEF 623. At step 5, the NEF 623 invokes Nnef_ServiceParameter_Response (Transaction-Id) to the AF 628.

In some cases, Provisioning Server address(es) may be pre-configured in UE 502 as described in step D1. In these cases, it may that the onboarding network may not be able to change the pre-configured address at UE 502. Here it is assumed that in case the UE 502 has pre-configured Provisioning Server address(es) the onboarding network is able to configure new Provisioning Server address(es) to the UE 502 as follows.

Provisioning Server address may be provided to UE 502 by SMF 624 as part of PDU Session establishment. Upon UE 502 requesting Configuration PDU Session the SMF 624 requests policy configuration data from PCF 626. On establishment of SM Policy Association as specified in [T523502] clause 4.16.4, the PCF 626 acquires policy data for onboarding by invoking UDR (API) with S-NSSAI and Onboarding DNN.

Provisioning Server address is part of policy data at or UDM 627). PCF 626 provides Provisioning Server address(es) as part of SM policy data to SMF 624. Based on restricted/provisioning indication from AMF 621, the SMF 624 sets appropriate user plane filters (PDR/FAR) with selected/onboarding designated UPF based on SM policy data received from PCF 626.

The SMF 624 may deliver the Provisioning Server address(es) as part of extended Protocol Configuration Options (PCO) in PDU Session Establishment Response to the UE 502. This is similar to use of PCO to configure Autoconfiguration server for UE 502 in Wireless and Wireline Convergence (see e.g., 3GPP TR 23.716 v16.0.0 (2018 Dec. 19), clause 6.10).

Alternatively, Provisioning Server address(es) may be configured to UE 502 during Registration Procedure using UE Route Selection Policy (URSP) that may be subject UE capabilities.

As part of UE initial registration (based on received UE capability information) AMF 621 indicates to PCF 626 that UE 502 has requested restricted/provisioning registration. The PCF 626 may initiate UE Policy delivery using URSP, for instance to trigger UE 502 after successful registration to request establishment of specific type of PDU Session limited to onboarding purposes only.

In addition, Provisioning Server address(es) may be configured to UE 502 using service specific policies subject to UE capabilities similar to what is used for V2X communications as specified in 3GPP TS 23.287 v16.0.0 (2019 Sep. 24) (“[T523287]”) clause 5.1.1 for ways how parameters may be made available to the UE 502 and [TS23287] clause 6.2.5 for AF-based service parameter provisioning and 3GPP TS 24.587 v0.3.0 (2019 Oct. 17) clause 5.2.4 for configuration parameters such as validity timer, server address and geographical area.

In some embodiments, during the registration procedure, the UE 502 provides information to the SNPN indicating that the registration is for restricted onboarding service only.

In some embodiments, during configuration PDU Session Establishment procedure, the UE 502 may provide information for PS and/or SO-SNPN 230 selection to the network in the PDU Session Establishment Request and may receive information for PS and/or SO-SNPN 230 selection from the network in the PDU Session Establishment Accept. In some embodiments, during configuration PDU Session Establishment procedure, the 5GC 520 may receive information for PS 220 and/or SO-SNPN 230 selection from the UE 502 in the PDU Session Establishment Request and may provide information for PS 220 and/or SO-SNPN 230 selection to the UE 502 in the PDU Session Establishment Accept. In some embodiments, the 5GC 520 may trigger PDU Session release or de-registration when time duration is expired.

In some embodiments, the UE 502 might have been provisioned with some initial default configuration, including PLMN ID and NID of the SNPN, S-NSSAI, DNN needed to access the provisioning server, and a list of ON Group IDs. If multiple networks are broadcasting the “Support for onboarding” indication, then the UE 502 will select a network at random. In some embodiments, the NG-RAN 514 may obtain and/or distribute a new indication in SIB, and a list of ON Group IDs to indicate that the SNPN provides access to onboarding service.

### 3. Example Systems and Device Configurations and Arrangements

Referring now to FIG. 5, which illustrates a network 500 in accordance with various embodiments. The network 500 may operate in a manner consistent with 3GPP technical specifications for Long Term Evolution (LTE) or 5G/NR systems. However, the example embodiments are not limited in this regard and the described embodiments may apply to other networks that benefit from the principles described herein, such as future 3GPP systems, or the like.

The network 500 includes a UE 502, which is any mobile or non-mobile computing device designed to communicate with a RAN 504 via an over-the-air connection. The UE 502 is communicatively coupled with the RAN 504 by a Uu interface, which may be applicable to both LTE and NR systems. Examples of the UE 502 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 500 may include a plurality of UEs 502 coupled directly with one another via a D2D, ProSe, PCS, and/or sidelink (SL) interface. These UEs 502 may be M2M/D2D/MTC/IoT devices and/or vehicular systems that communicate using physical SL channels such as, but not limited to, Physical Sidelink Broadcast Channel (PSBCH), Physical Sidelink Discovery Channel (PSDCH), Physical Sidelink Shared Channel (PSSCH), Physical Sidelink Control Channel (PSCCH), Physical Sidelink Feedback Channel (PSFCH), etc.

In some embodiments, the UE 502 may additionally communicate with an AP 506 via an over-the-air (OTA) connection. The AP 506 manages a WLAN connection, which may serve to offload some/all network traffic from the RAN 504. The connection between the UE 502 and the AP 506 may be consistent with any IEEE 802.11 protocol. Additionally, the UE 502, RAN 504, and AP 506 may utilize cellular-WLAN aggregation/integration (e.g., LWA/LWIP). Cellular-WLAN aggregation may involve the UE 502 being configured by the RAN 504 to utilize both cellular radio resources and WLAN resources.

The UE 502 may be configured to perform signal and/or cell measurements based on a configuration obtain from the network (e.g., RAN 504). The UE 502 derives cell measurement results by measuring one or multiple beams per cell as configured by the network. For all cell measurement results, the UE 502 applies layer 3 (L3) filtering before using the measured results for evaluation of reporting criteria and measurement reporting. For cell measurements, the network can configure Reference Signal Received Power (RSRP), Reference Signal Received Quality (RSRQ), and/or Signal-to-Interference plus Noise Ratio (SINR) as a trigger quantity. Reporting quantities can be the same as the trigger quantity or combinations of quantities (e.g., RSRP and RSRQ; RSRP and SINR; RSRQ and SINR; RSRP, RSRQ and SINR). In other embodiments, other measurements and/or combinations of measurements may be used as a trigger quantity such as those discussed in 3GPP TS 36.214 v15.3.0 (2018 Sep. 27) (hereinafter “[T536214]”), 3GPP TS 38.215 v15.5.0 (2019 Jun. 24) (hereinafter “[TS38215]”), Institute of Electrical and Electronics Engineers (IEEE) Standards Association, “IEEE Computer Society: “Part 11: Wireless LAN Medium Access Control (MAC) and Physical Layer (PHY) Specifications”, IEEE Std 802.11™-2012 (2012) (hereinafter “[IEEE80211]”), and/or the like.

The RAN 504 includes one or more access network nodes (ANs) 508. The ANs 508 terminate air-interface(s) for the UE 502 by providing access stratum protocols including Radio Resource Control (RRC), Packet Data Convergence Protocol (PDCP), Radio Link Control (RLC), Medium Access Control (MAC), and physical (PHY/L1) layer protocols. In this manner, the AN 508 enables data/voice connectivity between CN 520 and the UE 502. The UE 502 and can be configured to communicate using OFDM communication signals with other UEs 502 or with any of the AN 508 over a multicarrier communication channel in accordance with various communication techniques, such as, but not limited to, an OFDMA communication technique (e.g., for DL communications) or a SC-FDMA communication technique (e.g., for UL and SL communications), although the scope of the embodiments is not limited in this respect. The OFDM signals comprise a plurality of orthogonal subcarriers.

The ANs 508 may be a macrocell base station or a low power base station for providing femtocells, picocells or other like cells having smaller coverage areas, smaller user capacity, or higher bandwidth compared to macrocells; or some combination thereof. In these implementations, an AN 508 be referred to as a BS, gNB, RAN node, eNB, ng-eNB, NodeB, RSU, TRxP, etc.

One example implementation is a “CU/DU split” architecture where the ANs 508 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see e.g., 3GPP TS 38.401 v15.7.0 (2020 Jan. 09)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 508 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 504 is an LTE RAN or Evolved Universal Terrestrial Radio Access Network (E-UTRAN) 510) or an Xn interface (if the RAN 504 is a NG-RAN 514). The X2/Xn interfaces, which may be separated into control/user plane interfaces in some embodiments, may allow the ANs to communicate information related to handovers, data/context transfers, mobility, load management, interference coordination, etc.

The ANs of the RAN 504 may each manage one or more cells, cell groups, component carriers, etc. to provide the UE 502 with an air interface for network access. The UE 502 may be simultaneously connected with a plurality of cells provided by the same or different ANs 508 of the RAN 504. For example, the UE 502 and RAN 504 may use carrier aggregation (CA) to allow the UE 502 to connect with a plurality of component carriers, each corresponding to a PCell or SCell. A PCell is an MCG cell, operating on a primary frequency, in which the UE 502 performs an initial connection establishment procedure and/or initiates a connection re-establishment procedure. An SCell is a cell providing additional radio resources on top of a Special Cell (SpCell) when the UE 502 is configured with CA. In CA, two or more Component Carriers (CCs) are aggregated. The UE 502 may simultaneously receive or transmit on one or multiple CCs depending on its capabilities. A UE 502 with single timing advance capability for CA can simultaneously receive and/or transmit on multiple CCs corresponding to multiple serving cells sharing the same timing advance (multiple serving cells grouped in one timing advance group (TAG)). A UE 502 with multiple timing advance capability for CA can simultaneously receive and/or transmit on multiple CCs corresponding to multiple serving cells with different timing advances (multiple serving cells grouped in multiple TAGs). The NG-RAN 514 ensures that each TAG contains at least one serving cell; A non-CA capable UE 502 can receive on a single CC and transmit on a single CC corresponding to one serving cell only (one serving cell in one TAG). CA is supported for both contiguous and non-contiguous CCs. When CA is deployed frame timing and SFN are aligned across cells that can be aggregated, or an offset in multiples of slots between the PCell/PSCell and an SCell is configured to the UE 502. In some implementations, the maximum number of configured CCs for a UE 502 is 16 for DL and 16 for UL.

In Dual Connectivity (DC) scenarios, a first AN 508 may be a master node that provides a Master Cell Group (MCG) and a second AN 508 may be secondary node that provides an Secondary Cell Group (SCG). The first and second ANs 508 may be any combination of eNB, gNB, ng-eNB, etc. The MCG is a subset of serving cells comprising the PCell and zero or more SCells. The SCG is a subset of serving cells comprising the PSCell and zero or more SCells. As alluded to previously, DC operation involves the use of PSCells and SpCells. A PSCell is an SCG cell in which the UE 502 performs random access (RA) when performing a reconfiguration with Sync procedure, and an SpCell for DC operation is a PCell of the MCG or the PSCell of the SCG; otherwise the term SpCell refers to the PCell. Additionally, the PCell, PSCells, SpCells, and the SCells can operate in the same frequency range (e.g., FR1 or FR2), or the PCell, PSCells, SpCells, and the SCells can operate in different frequency ranges. In one example, the PCell may operate in a sub-6 GHz frequency range/band and the SCell can operate at frequencies above 24.25 GHz (e.g., FR2).

The RAN 504 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In some embodiments, the RAN 504 may be an E-UTRAN 510 with one or more eNBs 512. The E-UTRAN 510 provides an LTE air interface (Uu) with the following characteristics: subcarrier spacing (SCS) of 15 kHz; cyclic prefix (CP)-OFDM waveform for DL and SC-FDMA waveform for UL; turbo codes for data and TBCC for control; etc. The LTE air interface may rely on channel state information reference signals (CSI-RS) for channel state information (CSI) acquisition and beam management; Physical Downlink Shared Channel (PDSCH)/Physical Downlink Control Channel (PDCCH) Demodulation Reference Signal (DMRS) for PDSCH/PDCCH demodulation; and cell-specific reference signals (CRS) for cell search and initial acquisition, channel quality measurements, and channel estimation for coherent demodulation/detection at the UE. The LTE air interface may operating on sub-6 GHz bands.

In some embodiments, the RAN 504 may be an next generation (NG)-RAN 514 with one or more gNB 516 and/or on or more ng-eNB 518. The gNB 516 connects with 5G-enabled UEs 502 using a 5G NR interface. The gNB 516 connects with a 5GC 540 through an NG interface, which includes an N2 interface or an N3 interface. The ng-eNB 518 also connects with the 5GC 540 through an NG interface, but may connect with a UE 502 via the Uu interface. The gNB 516 and the ng-eNB 518 may connect with each other over an Xn interface.

In some embodiments, the NG interface may be split into two parts, an NG user plane (NG-U) interface, which carries traffic data between the nodes of the NG-RAN 514 and a UPF (e.g., N3 interface), and an NG control plane (NG-C) interface, which is a signaling interface between the nodes of the NG-RAN 514 and an AMF 621 (e.g., N2 interface).

The NG-RAN 514 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use Physical Broadcast Channel (PBCH) DMRS for PBCH demodulation; Phase Tracking Reference Signals (PTRS) for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an Synchronization Signal Block (SSB) that is an area of a DL resource grid that includes Primary Synchronization Signal (PSS)/Secondary Synchronization Signal (SSS)/PBCH.

The 5G-NR air interface may utilize bandwidth parts (BWPs) for various purposes. For example, BWP can be used for dynamic adaptation of the SCS. A BWP is a subset of contiguous common resource blocks defined in clause 4.4.4.3 of 3GPP TS 38.211 or a given numerology in a BWP on a given carrier. For example, the UE 502 can be configured with multiple BWPs where each BWP configuration has a different SCS. When a BWP change is indicated to the UE 502, the SCS of the transmission is changed as well. Another use case example of BWP is related to power saving. In particular, multiple BWPs can be configured for the UE 502 with different amount of frequency resources (e.g., PRBs) to support data transmission under different traffic loading scenarios. A BWP containing a smaller number of PRBs can be used for data transmission with small traffic load while allowing power saving at the UE 502 and in some cases at the gNB 516. A BWP containing a larger number of PRBs can be used for scenarios with higher traffic load.

The RAN 504 is communicatively coupled to CN 520, which includes network elements and/or network functions (NFs) to provide various functions to support data and telecommunications services to customers/subscribers (e.g., UE 502). The network elements and/or NFs may be implemented by one or more servers 521, 541. The components of the CN 520 may be implemented in one physical node or separate physical nodes. In some embodiments, NFV may be utilized to virtualize any or all of the functions provided by the network elements of the CN 520 onto physical compute/storage resources in servers, switches, etc. A logical instantiation of the CN 520 may be referred to as a network slice, and a logical instantiation of a portion of the CN 520 may be referred to as a network sub-slice.

The CN 520 may be an LTE CN 522 (also referred to as an Evolved Packet Core (EPC) 522). The EPC 522 may include MME, SGW, SGSN, HSS, PGW, PCRF, and/or other NFs coupled with one another over various interfaces (or “reference points”) (not shown). The CN 520 may be a 5GC 540 including an AUSF, AMF, SMF, UPF, NSSF, NEF, NRF, PCF, UDM, AF, and/or other NFs coupled with one another over various service-based interfaces and/or reference points (see e.g., FIGS. 6 and 7). The 5GC 540 may enable edge computing by selecting operator/3rd party services to be geographically close to a point that the UE 502 is attached to the network. This may reduce latency and load on the network. In edge computing implementations, the 5GC 540 may select a UPF close to the UE 502 and execute traffic steering from the UPF to DN 536 via the N6 interface. This may be based on the UE subscription data, UE location, and information provided by the AF 628, which allows the AF 628 to influence UPF (re)selection and traffic routing.

The data network (DN) 536 may represent various network operator services, Internet access, or third party services that may be provided by one or more servers including, for example, application (app)/content server 538. The DN 536 may be an operator external public, a private PDN, or an intra-operator packet data network, for example, for provision of IMS services. In this embodiment, the server 538 can be coupled to an IMS via an S-CSCF or the I-CSCF. In some implementations, the DN 536 may represent one or more local area DNs (LADNs), which are DNs 536 (or DN names (DNNs)) that is/are accessible by a UE 502 in one or more specific areas. Outside of these specific areas, the UE 502 is not able to access the LADN/DN 536.

Additionally or alternatively, the DN 536 may be an Edge DN 536, which is a (local) Data Network that supports the architecture for enabling edge applications. In these embodiments, the app server 538 may represent the physical hardware systems/devices providing app server functionality and/or the application software resident in the cloud or at an edge compute node that performs server function(s). In some embodiments, the app/content server 538 provides an edge hosting environment that provides support required for Edge Application Server's execution.

In some embodiments, the 5GS can use one or more edge compute nodes to provide an interface and offload processing of wireless communication traffic. In these embodiments, the edge compute nodes may be included in, or co-located with one or more RAN 510, 514. For example, the edge compute nodes can provide a connection between the RAN 514 and UPF in the 5GC 540. The edge compute nodes can use one or more NFV instances instantiated on virtualization infrastructure within the edge compute nodes to process wireless connections to and from the RAN 514 and a UPF 602.

In some implementations, the system 500 may include an SMSF, which is responsible for SMS subscription checking and verification, and relaying SM messages to/from the UE 502 to/from other entities, such as an SMS-GMSC/IWMSC/SMS-router. The SMS may also interact with AMF and UDM for a notification procedure that the UE 502 is available for SMS transfer (e.g., set a UE not reachable flag, and notifying UDM when UE 502 is available for SMS).

FIGS. 6 and 7 illustrate example system architectures 600 and 700 (collectively “5GC 600”) of a 5GC such as CN 540 of FIG. 5, in accordance with various embodiments. In particular, FIG. 6 shows an exemplary 5G system architecture 600 in a reference point representation where interactions between NFs are represented by corresponding point-to-point reference points Ni, and FIG. 7 illustrates an exemplary 5G system architecture 700 in a service-based representation where interactions between NFs are represented by corresponding service-based interfaces. The system 600 is shown to include a UE 601, which may be the same or similar to the UEs 502 discussed previously; a (R)AN 610, which may be the same or similar to the AN 508 discussed previously; and a DN 603, which may be, for example, operator services, Internet access or 3rd party services, and may correspond with a Packet Data Network in LTE systems; and a 5GC 620. The 5GC 620 may include an an Access and Mobility Management Function (AMF) 621; an Authentication Server Function (AUSF) 622; a Session Management Function (SMF) 624; a Network Exposure Function (NEF) 623; a Policy Control Function (PCF) 626; an NF Repository Function (NRF) 625; a Unified Data Management (UDM) 627; an Application Function (AF) 628; a User Plane Function (UPF) 602; a Network Slice Selection Function (NSSF) 629; a Service Communication Proxy (SCP) 630; and a Network Slice Specific Authentication and Authorization Function (NSSAAF) 631.

The reference point representation of FIG. 6 shows various interactions between corresponding NFs. For example, FIG. 6 illustrates the following reference points: N1 (between the UE 601 and the AMF 621), N2 (between the RAN 610 and the AMF 621), N3 (between the RAN 610 and the UPF 602), N4 (between the SMF 624 and the UPF 602), N5 (between the PCF 626 and the AF 628), N6 (between the UPF 602 and the DN 603), N7 (between the SMF 624 and the PCF 626), N8 (between the UDM 627 and the AMF 621), N9 (between two UPFs 602), N10 (between the UDM 627 and the SMF 624), N11 (between the AMF 621 and the SMF 624), N12 (between the AUSF 622 and the AMF 621), N13 (between the AUSF 622 and the UDM 627), N14 (between two AMFs 621), N15 (between the PCF 626 and the AMF 621 in case of a non-roaming scenario, or between the PCF 626 and a visited network and AMF 621 in case of a roaming scenario), N16 (between two SMFs; not shown), and N22 (between AMF 621 and NSSF 625). Other reference point representations not shown in FIG. 6 can also be used (see e.g., [T523501], clause 4.2.7).

The service-based representation of FIG. 7 represents NFs within the control plane that enable other authorized NFs to access their services. In this regard, 5G system architecture 300 can include the following service-based interfaces: Namf (a service-based interface exhibited by the AMF 621), Nsmf (a service-based interface exhibited by the SMF 624), Nnef (a service-based interface exhibited by the NEF 623), Npcf (a service-based interface exhibited by the PCF 626), Nudm (a service-based interface exhibited by the UDM 627), Naf (a service-based interface exhibited by the AF 628), Nnrf (a service-based interface exhibited by the NRF 625), Nnssf (a service-based interface exhibited by the NSSF 629), Nausf (a service-based interface exhibited by the AUSF 622), and Nnssaaf (a service-based interface exhibited by NSSAAF). Other service-based interfaces (e.g., Nudr, N5g-eir, and Nudsf) not shown in FIG. 7 can also be used. In embodiments, the NEF 623 can provide an interface to Edge node 636, which can be used to process wireless connections with the RAN 610.

The 5GS 600 is assumed to operate with a large number of UEs 601 used for CIoT and capable of appropriately handling overload and congestion situations. UEs 601 used for CIoT can be mobile or nomadic/static, and resource efficiency should be considered for both for relevant optimization(s). The 5GS 600 also supports one or more small data delivery mechanisms using IP data and Unstructured (Non-IP) data.

The AUSF 622 stores data for authentication of UE 601 and handle authentication-related functionality. The AUSF 622 may facilitate a common authentication framework for various access types. The AUSF 622 may communicate with the AMF 621 via an N12 reference point between the AMF 621 and the AUSF 622; and may communicate with the UDM 627 via an N13 reference point between the UDM 627 and the AUSF 622. Additionally, the AUSF 622 may exhibit an Nausf service-based interface.

The AMF 621 allows other functions of the 5GC 600 to communicate with the UE 601 and the RAN 610 and to subscribe to notifications about mobility events with respect to the UE 601. The AMF 621 is also responsible for registration management (e.g., for registering UE 601), connection management, reachability management, mobility management, lawful interception of AMF-related events, and access authentication and authorization. The AMF 621 provides transport for SM messages between the UE 601 and the SMF 624, and acts as a transparent proxy for routing SM messages. AMF 621 also provides transport for SMS messages between UE 601 and an SMSF. AMF 544 interacts with the AUSF 622 and the UE 601 to perform various security anchor and context management functions. Furthermore, AMF 621 is a termination point of a RAN-CP interface, which includes the N2 reference point between the RAN 610 and the AMF 621. The AMF 621 is also a termination point of Non-Access Stratum (NAS) (N1) signaling, and performs NAS ciphering and integrity protection.

The AMF 621 also supports NAS signaling with the UE 601 over an N3IWF interface. The N3IWF provides access to untrusted entities. N3IWF may be a termination point for the N2 interface between the (R)AN 610 and the AMF 621 for the control plane, and may be a termination point for the N3 reference point between the (R)AN 610 and the UPF 602 for the user plane. As such, the AMF 621 handles N2 signalling from the SMF 624 and the AMF 621 for PDU sessions and QoS, encapsulate/de-encapsulate packets for IPSec and N3 tunnelling, marks N3 user-plane packets in the uplink, and enforces QoS corresponding to N3 packet marking taking into account QoS requirements associated with such marking received over N2. N3IWF may also relay UL and DL control-plane NAS signalling between the UE 601 and AMF 621 via an N1 reference point between the UE 601 and the AMF 621, and relay uplink and downlink user-plane packets between the UE 601 and UPF 602. The N3IWF also provides mechanisms for IPsec tunnel establishment with the UE 601. The AMF 621 may exhibit an Namf service-based interface, and may be a termination point for an N14 reference point between two AMFs 640 and an N17 reference point between the AMF 621 and a 5G-EIR (not shown by FIG. 5).

The SMF 624 is responsible for SM (e.g., session establishment, tunnel management between UPF 602 and (R)AN 610); UE IP address allocation and management (including optional authorization); selection and control of UP function; configuring traffic steering at UPF 602 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 621 over N2 to (R)AN 610; and determining SSC mode of a session. SM refers to management of a PDU session, and a PDU session or “session” refers to a PDU connectivity service that provides or enables the exchange of PDUs between the UE 601 and the DN 603.

The UPF 602 acts as an anchor point for intra-RAT and inter-RAT mobility, an external PDU session point of interconnect to data network 603, and a branching point to support multi-homed PDU session. The UPF 602 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 602 may include an uplink classifier to support routing traffic flows to a data network.

The NSSF 629 selects a set of network slice instances serving the UE 601. The NSSF 629 also determines allowed NSSAI and the mapping to the subscribed S-NSSAIs, if needed. The NSSF 629 also determines an AMF set to be used to serve the UE 601, or a list of candidate AMFs 621 based on a suitable configuration and possibly by querying the NRF 625. The selection of a set of network slice instances for the UE 601 may be triggered by the AMF 621 with which the UE 601 is registered by interacting with the NSSF 629; this may lead to a change of AMF 621. The NSSF 629 interacts with the AMF 621 via an N22 reference point; and may communicate with another NSSF in a visited network via an N31 reference point (not shown).

The NEF 623 securely exposes services and capabilities provided by 3GPP NFs for third party, internal exposure/re-exposure, AFs 628, edge computing or fog computing systems (e.g., edge compute node 636, etc. In such embodiments, the NEF 623 may authenticate, authorize, or throttle the AFs 628. NEF 623 may also translate information exchanged with the AF 628 and information exchanged with internal network functions. For example, the NEF 623 may translate between an AF-Service-Identifier and an internal SGC information. NEF 623 may also receive information from other NFs based on exposed capabilities of other NFs. This information may be stored at the NEF 623 as structured data, or at a data storage NF using standardized interfaces. The stored information can then be re-exposed by the NEF 623 to other NFs and AFs 628, or used for other purposes such as analytics. External exposure of network capabilities towards Services Capabilities Server (SCS)/app server 640 or AF 628 is supported via the NEF 623. Notifications and data from NFs in the Visiting Public Land Mobile Network (VPLMN) to the NEF 623 can be routed through an interworking (IWK)-NEF (not shown), similar to the IWK-Service Capability Exposure Function (SCEF) in an EPC (not shown).

The NRF 625 supports service discovery functions, receives NF discovery requests from NF instances, and provides information of the discovered NF instances to the requesting NF instances. NRF 625 also maintains information of available NF instances and their supported services. The NRF 625 also supports service discovery functions, wherein the NRF 625 receives NF Discovery Request from NF instance or an SCP 630, and provides information of the discovered NF instances to the NF instance or SCP 630.

The PCF 626 provides policy rules to control plane functions to enforce them, and may also support unified policy framework to govern network behavior. The PCF 626 may also implement a front end to access subscription information relevant for policy decisions in a UDR of the UDM 627. In addition to communicating with functions over reference points as shown, the PCF 626 exhibit an Npcf service-based interface.

The UDM 627 handles subscription-related information to support the network entities' handling of communication sessions, and stores subscription data of UE 601. For example, subscription data may be communicated via an N8 reference point between the UDM 627 and the AMF 621. The UDM 627 may include two parts, an application front end and a UDR. The UDR may store subscription data and policy data for the UDM 627 and the PCF 626, and/or structured data for exposure and application data (including PFDs for application detection, application request information for multiple UEs 601) for the NEF 623. The Nudr service-based interface may be exhibited by the UDR 221 to allow the UDM 627, PCF 626, and NEF 623 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 627 may exhibit the Nudm service-based interface.

The AF 628 provides application influence on traffic routing, provide access to NEF 623, and interact with the policy framework for policy control. The AF 628 may influence UPF 602 (re)selection and traffic routing. Based on operator deployment, when AF 628 is considered to be a trusted entity, the network operator may permit AF 628 to interact directly with relevant NFs.

Additionally, the AF 628 may be used for edge computing implementations. The 5GC 600 may enable edge computing by selecting operator/3rd party services to be geographically close to a point that the UE 601 is attached to the network. This may reduce latency and load on the network. In edge computing implementations, the 5GC 600 may select a UPF 602 close to the UE 502 and execute traffic steering from the UPF 602 to DN 603 via the N6 interface. This may be based on the UE subscription data, UE location, and information provided by the AF 628, which allows the AF 628 to influence UPF (re)selection and traffic routing.

The DN 603 may represent various network operator services, Internet access, or third party services that may be provided by one or more servers including, for example, application (app)/content server 640. The DN 603 may be an operator external public, a private PDN, or an intra-operator packet data network, for example, for provision of IMS services. In this embodiment, the app server 640 can be coupled to an IMS via an S-CSCF or the I-CSCF. In some implementations, the DN 603 may represent one or more local area DNs (LADNs), which are DNs 603 (or DN names (DNNs)) that is/are accessible by a UE 601 in one or more specific areas. Outside of these specific areas, the UE 601 is not able to access the LADN/DN 603.

In some implementations, the application programming interfaces (APIs) for CIoT related services provided to the SCS/app server 640 is/are common for UEs 601 connected to an EPS and 5GS 600 and accessed via an Home Public Land Mobile Network (HPLMN). The level of support of the APIs may differ between EPS and 5GS. CIoT UEs 601 can simultaneously connect to one or multiple SCSs/app servers 640 and/or Afs 628.

In some implementations, the DN 603 may be, or include, one or more edge compute nodes 636. Additionally or alternatively, the DN 603 may be an Edge DN 603, which is a (local) Data Network that supports the architecture for enabling edge applications. In these embodiments, the app server 640 may represent the physical hardware systems/devices providing app server functionality and/or the application software resident in the cloud or at an edge compute node 636 that performs server function(s). In some embodiments, the app/content server 640 provides an edge hosting environment that provides support required for Edge Application Server's execution.

In some embodiments, the 5GS can use one or more edge compute nodes 636 to provide an interface and offload processing of wireless communication traffic. In these embodiments, the edge compute nodes 636 may be included in, or co-located with one or more RANs 610. For example, the edge compute nodes 636 can provide a connection between the RAN 610 and UPF 602 in the 5GC 600. The edge compute nodes 636 can use one or more NFV instances instantiated on virtualization infrastructure within the edge compute nodes 636 to process wireless connections to and from the RAN 610 and UPF 602.

In embodiments, the edge node 636 may include or be part of an edge system (or edge network). The edge node 636 may also be referred to as “edge hosts 636” or “edge servers 636.” The edge system includes a collection of edge servers 636 and edge management systems (not shown) necessary to run edge computing applications within an operator network or a subset of an operator network. The edge servers 636 are physical computer systems that may include an edge platform and/or virtualization infrastructure, and provide compute, storage, and network resources to edge computing applications. Each of the edge servers 636 are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 501, 601 The VI of the edge servers 636 provide virtualized environments and virtualized resources for the edge hosts, and the edge computing applications may run as VMs and/or application containers on top of the VI. Various edge computing/networking technologies in various combinations and layouts of devices located at the edge of a network may be used. Examples of such edge computing/networking technologies that may implement the embodiments herein include ETSI MEC; CDNs Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used to practice the embodiments herein.

The SCP 630 (or individual instances of the SCP 630) supports indirect communication (see e.g., [T523501], section 7.1.1); delegated discovery (see e.g., [T523501] section 7.1.1); message forwarding and routing to destination NF/NF service(s), communication security (e.g., authorization of the NF Service Consumer to access the NF Service Producer API), load balancing, monitoring, overload control, etc.; and discovery and selection functionality for UDM(s), AUSF(s), UDR(s), PCF(s) with access to subscription data stored in the UDR based on UE's 502 SUPI, SUCI or GPSI (see e.g., [T523501] section 6.3). Load balancing, monitoring, overload control functionality provided by the SCP may be implementation specific. The SCP 230 may be deployed in a distributed manner. More than one SCP 630 can be present in the communication path between various NF Services. The SCP 630, although not an NF instance, can also be deployed distributed, redundant, and scalable. An SCP Domain is a configured group of one or more SCP(s) 630 and zero or more NF instances(s). An SCP 630 within the group can communicate with any NF instance or SCP 630 within the same group directly (e.g., without passing through an intermediate SCP 630).

The NSSAAF 631 supports Network Slice-Specific Authentication and Authorization as specified in [T523502] with a AAA Server (AAA-S). If the AAA-S belongs to a third party, the NSSAAF may contact the AAA-S via an a AAA proxy (AAA-P).

The system architecture 600/300 may also include other elements that are not shown by FIG. 6 or 3, such as a Data Storage system/architecture, a 5G-EIR, a SEPP, and the like. The Data Storage system may include a SDSF, an UDSF, and/or the like. Any NF may store and retrieve unstructured data into/from the UDSF (e.g., UE contexts), via N18 reference point between any NF and the UDSF (not shown by FIG. 2). Individual NFs may share a UDSF for storing their respective unstructured data or individual NFs may each have their own UDSF located at or near the individual NFs. Additionally, the UDSF may exhibit an Nudsf service-based interface (not shown by FIG. 2). The 5G-EIR may be an NF that checks the status of PEI for determining whether particular equipment/entities are blacklisted from the network; and the SEPP may be a non-transparent proxy that performs topology hiding, message filtering, and policing on inter-PLMN control plane interfaces.

In another example, the 5G system architecture 600 includes an IP multimedia subsystem (IMS) as well as a plurality of IP multimedia core network subsystem entities, such as call session control functions (CSCFs) (not shown by FIG. 6 or 3). More specifically, the IMS includes a CSCF, which can act as a proxy CSCF (P-CSCF), a serving CSCF (S-CSCF), an emergency CSCF (E-CSCF), or interrogating CSCF (I-CSCF). The P-CSCF can be configured to be the first contact point for the UE 601 within the IMS. The S-CSCF can be configured to handle the session states in the network, and the E-CSCF can be configured to handle certain aspects of emergency sessions such as routing an emergency request to the correct emergency center or public safety answering point (PSAP). The I-CSCF can be configured to function as the contact point within an operator's network for all IMS connections destined to a subscriber of that network operator, or a roaming subscriber currently located within that network operator's service area. In some aspects, the I-CSCF can be connected to another IP multimedia network, for example, an IMS operated by a different network operator.

In some implementations, the 5GS architecture also includes a Security Edge Protection Proxy (SEPP) as an entity sitting at the perimeter of the PLMN for protecting control plane messages. The SEPP enforces inter-PLMN security on the N32 interface. The 5GS architecture may also include an Inter-PLMN UP Security (IPUPS) at the perimeter of the PLMN for protecting user plane messages. The IPUPS is a functionality of the UPF 602 that enforces GTP-U security on the N9 interface between UPFs 602 of the visited and home PLMNs. The IPUPS can be activated with other functionality in a UPF 602 or activated in a UPF 602 that is dedicated to be used for IPUPS functionality (see e.g., [T523501], clause 5.8.2.14).

Additionally, there may be many more reference points and/or service-based interfaces between the NF services in the NFs; however, these interfaces and reference points have been omitted from FIGS. 6 and 7 for clarity. In one example, the CN 620 may include an Nx interface, which is an inter-CN interface between the MME and the AMF 621 in order to enable interworking between system 700 and an EPC. Other example interfaces/reference points may include an N5g-EIR service-based interface exhibited by a 5G-EIR, an N27 reference point between the NRF in the visited network and the NRF in the home network; and an N31 reference point between the NSSF in the visited network and the NSSF in the home network.

FIG. 8 shows an example architecture for UE Onboarding to an SO-SNPN 230 according to various embodiments. Like numbered elements/entities shown by FIG. 8 are the same or similar to those discussed previously with respect to FIGS. 6 and 7. The AUSF* 622 inside the O-SNPN 210 is used to achieve isolation from 3rd party owned DCS 240, while keeping the same procedures between the AMF 621 and the AUSF 622 from the AMF 621 perspective (N12). The Authentication credential Repository and Processing Function (ARPF) in the DCS owner's domain is a functional element of the UDM responsible for generating 5G Home Environment Authentication Vectors (5G HE AV) based on the subscriber's shared secret key. The Subscriber Identity De-concealing Function (SIDF) in the DCS owner's domain is a functional element of the UDM responsible for decrypting a Subscription Concealed Identifier (SUCI) to reveal a subscriber's SUPI.

FIG. 9 illustrates an example of infrastructure equipment 900 in accordance with various embodiments. The infrastructure equipment 900 (or “system 900”) may be implemented as a base station, radio head, RAN node such as the AN 508 shown and described previously, application server(s) 538, and/or any other element/device discussed herein. In other examples, the system 900 could be implemented in or by a UE 501.

The system 900 includes application circuitry 905, baseband circuitry 910, one or more radio front end modules (RFEMs) 915, memory circuitry 920, power management integrated circuitry (PMIC) 925, power tee circuitry 930, network controller circuitry 935, network interface connector 940, satellite positioning circuitry 945, and user interface 950. In some embodiments, the device 900 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 905 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry x05 may be coupled with or may include memory/storage elements and may be configured to execute instructions stored in the memory/storage to enable various applications or operating systems to run on the system 900. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 905 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 905 may comprise, or may be, a special-purpose processor/controller to operate according to the various embodiments herein. As examples, the processor(s) of application circuitry 905 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 900 may not utilize application circuitry 905, and instead may include a special-purpose processor/controller to process IP data received from an EPC or SGC, for example.

In some implementations, the application circuitry 905 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 905 may comprise logic blocks or logic fabric, and other interconnected resources that may be programmed to perform various functions, such as the procedures, methods, functions, etc. of the various embodiments discussed herein. In such embodiments, the circuitry of application circuitry 905 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

The baseband circuitry 910 may be implemented, for example, as a solder-down substrate including one or more integrated circuits, a single packaged integrated circuit soldered to a main circuit board or a multi-chip module containing two or more integrated circuits.

User interface circuitry 950 may include one or more user interfaces designed to enable user interaction with the system 900 or peripheral component interfaces designed to enable peripheral component interaction with the system 900. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 915 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 5111 of FIG. 5 infra), and the RFEM may be connected to multiple antennas. In alternative implementations, both mmWave and sub-mmWave radio functions may be implemented in the same physical RFEM 915, which incorporates both mmWave antennas and sub-mmWave.

The memory circuitry 920 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 920 may be implemented as one or more of solder down packaged integrated circuits, socketed memory modules and plug-in memory cards.

The PMIC 925 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 930 provides for electrical power to be drawn from a network cable to provide both power supply and data connectivity to the infrastructure equipment 900 using a single cable.

The network controller circuitry 935 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 900 via network interface connector 940 using a physical connection, which may be electrical (commonly referred to as a “copper interconnect”), optical, or wireless. The network controller circuitry 935 may include one or more dedicated processors and/or FPGAs to communicate using one or more of the aforementioned protocols. In some implementations, the network controller circuitry 935 may include multiple controllers to provide connectivity to other networks using the same or different protocols.

The positioning circuitry 945 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 945 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 945 may include a Micro-Technology for Positioning, Navigation, and Timing (Micro-PNT) IC that uses a master timing clock to perform position tracking/estimation without GNSS assistance. The positioning circuitry 945 may also be part of, or interact with, the baseband circuitry 910 and/or RFEMs 915 to communicate with the nodes and components of the positioning network. The positioning circuitry 945 may also provide position data and/or time data to the application circuitry 905, which may use the data to synchronize operations with various infrastructure (e.g., AN 508, etc.), or the like.

The components shown by FIG. 9 may communicate with one another using interface circuitry, which may include any number of bus and/or interconnect (IX) technologies such as ISA, extended ISA, I2C, SPI, point-to-point interfaces, power management bus (PMBus), PCI, PCIe, PCIx, Intel® UPI, Intel® IAL, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, and/or any number of other IX technologies. The IX technology may be a proprietary bus, for example, used in an SoC based system.

FIG. 10 schematically illustrates a wireless network 1000 in accordance with various embodiments. The wireless network 1000 includes a UE 1002 in wireless communication with an AN 1004. The UE 1002 and AN 104 may be the same, similar to, and/or substantially interchangeable with, like-named components described elsewhere herein such as the UE 601 and RAN 504 of FIG. 5, and/or system 900 of FIG. 4.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHz frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

Although not shown, the components of UE 1002 and/or AN 1004 may communicate with one another using a suitable bus or interconnect (IX) technology, which may include any number of technologies, including ISA, extended ISA, I2C, SPI, point-to-point interfaces, power management bus (PMBus), PCI, PCIe, PCIx, Intel® UPI, Intel® IAL, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, and/or any number of other IX technologies. The IX technology may be a proprietary bus, for example, used in an SoC based system.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processor(s) 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface components or other suitable devices to communicate with one or more peripheral devices 1104 or one or more databases 1106 via a network 1108. For example, the communication resources 1130 may include wired communication components (e.g., for coupling via USB), cellular communication components, NFC components, Bluetooth® (or Bluetooth® Low Energy) components, Wi-Fi® components, and other communication components.

Instructions 650 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 650 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### 4. Example Implementations

FIGS. 12, 13, and 14 illustrate processes 1200, 1300, and 1400, respectively for practicing various embodiments herein. While particular examples and orders of operations are illustrated FIGS. 12, 13, and 14, the depicted orders of operations should not be construed to limit the scope of the embodiments in any way. Rather, the depicted operations may be re-ordered, broken into additional operations, combined, and/or omitted altogether while remaining within the spirit and scope of the present disclosure.

Process 1200 begins at operation 1201 where a UE 502 generates a message for establishing a connectivity to an onboarding server 120, 220. At operation 1202, the UE 502 transmits the message in an SNPN 110, 210.

Process 1300 begins at operation 1301 where an onboarding server 120, 220 decodes, upon reception from a UE 502, a message that include manufacturer credentials of the UE 502 for establishing a connectivity. At operation 1302, the onboarding server 120, 220 validates authority of the UE 502 based on the manufacturer credentials.

Process 14 begins at operation 1401 where, when a UE 502 establish a connection with an onboarding server 120, 220 using manufacturer/default credentials configured in the UE by a device manufacturer. The restricted connectivity from UE 502 to the onboarding server 120, 220 is provided by the SNPN 110, 210 based on principles similar to RLOS. The NG-RAN 514 in the SNPN 110, 210 broadcasts the system information (e.g., system information block (SIB)) about the support for Restricted Onboarding Services. The UE 502 indicates in the RRC establishment procedure that the connection is for Restricted Onboarding Services based on which the NG-RAN 514 selects the appropriate AMF 621 in the SNPN 110, 210. The AMF 621 selects a designated SMF 624 which in turn selects a designated PSA that provides a restricted data connection to the onboarding server 120, 220. At operation 1402, the onboarding server 120, 220 bootstraps HN 130 credentials to the UE 502, and the onboarding server 120, 220 provisions security credentials in the UE 502. In cooperation with the HN 130, onboarding server 120, 220 configures the UE 502 with network credentials that will allow the UE 502 to register with an NPN while being authenticated by the HN 130. At operation 1403, based on the HN 130 (security) credentials provisioning at operation 1402, the UE 502 initiates Registration procedure with the HN 130.

Additional examples of the presently described embodiments include the following, non-limiting implementations. Each of the following non-limiting examples may stand on its own or may be combined in any permutation or combination with any one or more of the other examples provided below or throughout the present disclosure.

Example 1 includes a method where a UE with only manufacturer credentials establishes a connection with an Onboarding Server to provision the UE with network credentials.

Example 2a includes the method of example 1 and/or some other example(s) herein, wherein the network credentials can be 3GPP credentials.

Example 2b includes the method of example 2a and/or some other example(s) herein, wherein the 3GPP credentials are SUbscription Permanent Identifier (SUPI) and associated key for Authentication and Key Agreement (AKA).

Example 3a includes the method of example 1 and/or some other example(s) herein, wherein the network credentials can be non-3GPP credentials.

Example 3b includes the method of example 3a and/or some other example(s) herein, wherein the non-3GPP credentials are user identifier in NAI format and associated digital certificate.

Example 4 includes the method of examples 1-3b and/or some other example(s) herein, wherein an NG-RAN in an SNPN is configured to broadcast system information about the support for Restricted Onboarding Service.

Example 5 includes the method of examples 1-4 and/or some other example(s) herein, wherein the UE indicates that the connection is for restricted onboarding service in the RRC Establishment procedure which enables the NG-RAN to select an appropriate AMF in the SNPN.

Example 6 includes the method of example 5 and/or some other example(s) herein, wherein an AMF selects a designated SMF which in turn selects a designated PSA that provides a restricted data connection to the Onboarding Server.

Example 7 includes the method of example 6 and/or some other example(s) herein, wherein the Onboarding Server validates the authenticity of the UE based on the manufacturer credentials.

Example 8 includes the method of example 7 and/or some other example(s) herein, wherein the Onboarding Server in agreement with the future Home Network of the UE configures the UE with network credentials that will allow the UE to register with an NPN while being authenticated by the home network (HN).

Example 9 includes the method of examples 7-8 and/or some other example(s) herein, wherein the network credentials are generated by the Onboarding Server and then pushed to the Home Network and also configure the UE with the network credentials.

Example 10 includes the method of examples 8-9 and/or some other example(s) herein, wherein where the UE based on the network credentials initiates Registration procedure with the Home network.

Example 11 includes a method, comprising: generating a message for establishing connectivity to an onboarding server; and transmitting the message in a Stand-alone Non-Public Network (SNPN).

Example 12 includes the method of example 11 and/or some other example(s) herein, wherein the message includes manufacturer credentials of a user equipment (UE).

Example 13 includes the method of example 12 and/or some other example(s) herein, wherein the connectivity to the onboarding server is an restricted connectivity from the UE to the onboard server.

Example 14 includes the method of example 13 and/or some other example(s) herein, wherein the restricted connectivity is provided by the SNPN.

Example 15 includes the method of examples 11-14 and/or some other example(s) herein, further comprising decoding, upon reception from the onboard server, one or more network credentials for establishing a connection to a home network (HN).

Example 16 includes the method of example 15 and/or some other example(s) herein, wherein the one or more network credentials include SUbscription Permanent Identifier (SUPI) and associated key for Authentication and Key Agreement (AKA), and other 3GPP-related credentials.

Example 17 includes the method of example 15 and/or some other example(s) herein, wherein the one or more network credentials include example user identifier in NAI format and associated digital certificate, and/or other non-3GPP-related credentials.

Example 18 includes the method of examples 11-14 and/or some other example(s) herein, further comprising indicating the connectivity to the onboard server is for the restricted connectivity.

Example 19 includes the method of examples 11-14 and/or some other example(s) herein, further comprising initiating, based on the decoded network credentials, a registration with the HN.

Example 20 includes the method of examples 11-19 and/or some other example(s) herein, wherein the method is to be performed by the UE or a portion thereof.

Example 21 includes a method comprising: decoding, upon reception from a UE, a message that include manufacturer credentials of the UE for establishing a connectivity; and validating authority of the UE based on the manufacturer credentials.

Example 22 includes the method of example 21 and/or some other example(s) herein, further comprising generating, based on the decoded message, one or more network credentials to the UE for establishing a future connection to a home network (HN).

Example 23 includes the method of examples 21-22 and/or some other example(s) herein, further comprising establishing a restricted data connection that is designated by a PDU Session Anchor (PSA).

Example 24 includes the method of example 23 and/or some other example(s) herein, wherein the PSA is designated by an SMF that is designated by an AMF.

Example 25 includes the method of examples 21-24 and/or some other example(s) herein, further comprising establishing an agreement with the HN.

Example 26 includes the method of example 25 and/or some other example(s) herein, further comprising determining the network credentials with the HN so that the UE is to be allowed for registration with the HN.

Example 27 includes the method of example 22 or 26 and/or some other example(s) herein, further comprising transmitting the network credentials to the HN.

Example 28 includes the method of examples 21-27 and/or some other example(s) herein, wherein the method is to be performed by an onboarding server or a portion thereof

Example 29 includes the method of example 28 and/or some other example(s) herein, wherein the onboarding server is in a Stand-alone Non-Public Network (SNPN).

Example 27 includes the method of examples 1-26 and/or some other examples herein, wherein the method is performed by a user equipment (UE).

Example A01 includes a method of operating a user equipment (UE), the method comprising: generating a message to establish a connection with an onboarding server for obtaining Non-Public Network (NPN) credentials, the message to include default credentials configured in the UE by a device manufacturer; transmitting the message to an onboarding server; and receiving the NPN credentials from the onboarding server based on the default credentials.

Example A02 includes the method of example A01 and/or some other example(s) herein, wherein the default credentials include default UE credentials for UE authentication and a unique UE identifier.

Example A03 includes the method of example A02 and/or some other example(s) herein, wherein the default credentials comprise a subscriber identifier (SUPI) that is a combination of a Public Land Mobile Network (PLMN) identifier (ID) and Network identifier (NID).

Example A04 includes the method of example A02 and/or some other example(s) herein, wherein the default credentials comprise a SUPI containing a network-specific identifier that takes the form of a Network Access Identifier (NAI) or a SUPI containing an international mobile subscriber identity (IMSI).

Example A05 includes the method of examples A02-A04 and/or some other example(s) herein, further comprising: discovering and selecting a Standalone NPN (SNPN) according to broadcasted information and configured information in the UE.

Example A06 includes the method of example A05 and/or some other example(s) herein, wherein the SNPN discovers and connects with a Default Credential Server (DCS) based on the unique UE identifier, and the SNPN authenticates the UE with the DCS to verify whether the UE is allowed to access the SNPN for onboarding purposes.

Example A07 includes the method of example A06 and/or some other example(s) herein, wherein the connection to be established is a Configuration Protocol Data Unit (PDU) session, and the method comprises: establishing the Configuration PDU session with the onboarding server.

Example A08 includes the method of example A07 and/or some other example(s) herein, wherein the onboarding server selects a home network and provides the subscription credentials for access to the home network.

Example A09 includes the method of examples A07-A08 and/or some other example(s) herein, further comprising: obtaining the NPN credentials for the home network over a secure connection of the Configuration PDU session.

Example A10 includes the method of examples A07-A09 and/or some other example(s) herein, further comprising: generating a registration message to include the NPN credentials; and transmitting the registration message to the home network to initiate a registration procedure with the home network.

Example A11 includes a method of operating an onboarding server, the method comprising: establishing a connection with a user equipment (UE); obtaining UE default credentials for obtaining Non-Public Network (NPN) credentials over the connection; obtaining the NPN credentials from a selected NPN based on the UE default credentials; and provisioning the UE with the NPN credentials.

Example A12 includes the method of example A11 and/or some other example(s) herein, wherein the established connection is a Configuration Protocol Data Unit (PDU) session.

Example A13 includes the method of example A12 and/or some other example(s) herein, further comprising: provisioning the NPN credentials for the home network over a secure connection of the Configuration PDU session.

Example A14 includes the method of example A11-A13 and/or some other example(s) herein, wherein the UE default credentials include a unique UE identifier.

Example A15 includes the method of examples A11-A14 and/or some other example(s) herein, wherein the UE default credentials comprise a subscriber identifier (SUPI) that is a combination of a Public Land Mobile Network (PLMN) identifier (ID) and Network identifier (NID).

Example A16 includes the method of examples A14-A15 and/or some other example(s) herein, wherein the UE default credentials comprise a SUPI containing a network-specific identifier that takes the form of a Network Access Identifier (NAI) or a SUPI containing an international mobile subscriber identity (IMSI).

Example A17 includes the method of examples A14-A16 and/or some other example(s) herein, further comprising: discovering and connecting with a Default Credential Server (DCS) based on the unique UE identifier; and obtaining an indication from the DCS indicating whether the UE is allowed to access the NPN or the onboarding server for onboarding purposes.

Example A18 includes the method of examples A14-A17 and/or some other example(s) herein, further comprising: comparing the unique UE identifier with a configured onboarding list; and selecting the NPN based on the comparison.

Example A19 includes the method of examples A11-A17 and/or some other example(s) herein, further comprising: obtaining an NPN identity from the UE; and selecting the NPN using the obtained NPN identity.

Example A20 includes the method of examples A11-A19 and/or some other example(s) herein, further comprising: generating the NPN credentials; and pushing the NPN credentials to the selected NPN.

Example Z01 may include an apparatus comprising means to perform one or more elements of a method described in or related to any of examples 1-27, A01-A20, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-27, A01-A20, or any other method or process described herein.

Example Z03 may include an apparatus comprising logic, modules, or circuitry to perform one or more elements of a method described in or related to any of examples 1-27, A01-A20, or any other method or process described herein.

Example Z04 may include a method, technique, or process as described in or related to any of examples 1-27, A01-A20, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-27, A01-A20, or portions thereof.

Example Z06 may include a signal as described in or related to any of examples 1-27, A01-A20, or portions or parts thereof.

Example Z07 may include a datagram, packet, frame, segment, protocol data unit (PDU), or message as described in or related to any of examples 1-27, A01-A20, or portions or parts thereof, or otherwise described in the present disclosure.

Example Z08 may include a signal encoded with data as described in or related to any of examples 1-27, A01-A20, or portions or parts thereof, or otherwise described in the present disclosure.

Example Z09 may include a signal encoded with a datagram, packet, frame, segment, protocol data unit (PDU), or message as described in or related to any of examples 1-27, A01-A20, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-27, A01-A20, or portions thereof.

Example Z11 may include a computer program comprising instructions, wherein execution of the program by a processing element is to cause the processing element to carry out the method, techniques, or process as described in or related to any of examples 1-27, A01-A20, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 5. Terminology

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like

The term “circuitry” refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an Application Specific Integrated Circuit (ASIC), a field-programmable gate array (FPGA), programmable logic device (PLD), complex PLD (CPLD), high-capacity PLD (HCPLD), System-on-Chip (SoC), System-in-Package (SiP), Multi-Chip Package (MCP), digital signal processor (DSP), etc., that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” as used herein refers to one or more hardware devices for storing data, including random access memory (RAM), magnetoresistive RAM (MRAM), phase change random access memory (PRAM), dynamic random access memory (DRAM) and/or synchronous dynamic random access memory (SDRAM), core memory, read only memory (ROM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, etc.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “architecture” as used herein refers to a computer architecture or a network architecture. A “network architecture” is a physical and logical design or arrangement of software and/or hardware elements in a network including communication protocols, interfaces, and media transmission. A “computer architecture” is a physical and logical design or arrangement of software and/or hardware elements in a computing system or platform including technology standards for interacts therebetween.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “SMTC” refers to an SSB-based measurement timing configuration configured by SSB-MeasurementTimingConfiguration. The term “SSB” refers to an SS/PBCH block. The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC CONNECTED not configured with CA/DC there is only one serving cell comprising of the primary cell. The term “serving cell” or “serving cells” refers to the set of cells comprising the Special Cell(s) and all secondary cells for a UE in RRC CONNECTED configured with carrier aggregation (CA). The term “Special Cell” refers to the PCell of the MCG or the PSCell of the SCG for DC operation; otherwise, the term “Special Cell” refers to the Pcell.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. Examples of wireless communications protocols may be used in various embodiments include a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology including, for example, 3GPP Fifth Generation (5G) or New Radio (NR), Universal Mobile Telecommunications System (UMTS), Freedom of Multimedia Access (FOMA), Long Term Evolution (LTE), LTE-Advanced (LTE Advanced), LTE Extra, LTE-A Pro, cdmaOne (2G), Code Division Multiple Access 2000 (CDMA 2000), Cellular Digital Packet Data (CDPD), Mobitex, Circuit Switched Data (CSD), High-Speed CSD (HSCSD), Universal Mobile Telecommunications System (UMTS), Wideband Code Division Multiple Access (W-CDM), High Speed Packet Access (HSPA), HSPA Plus (HSPA+), Time Division-Code Division Multiple Access (TD-CDMA), Time Division-Synchronous Code Division Multiple Access (TD-SCDMA), LTE LAA, MuLTEfire, UMTS Terrestrial Radio Access (UTRA), Evolved UTRA (E-UTRA), Evolution-Data Optimized or Evolution-Data Only (EV-DO), Advanced Mobile Phone System (AMPS), Digital AMPS (D-AMPS), Total Access Communication System/Extended Total Access Communication System (TACS/ETACS), Push-to-talk (PTT), Mobile Telephone System (MTS), Improved Mobile Telephone System (IMTS), Advanced Mobile Telephone System (AMTS), Cellular Digital Packet Data (CDPD), DataTAC, Integrated Digital Enhanced Network (iDEN), Personal Digital Cellular (PDC), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, 802.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), Long Range Wide Area Network (LoRA) or LoRaWAN™ developed by Semtech and the LoRa Alliance, Sigfox, Wireless Gigabit Alliance (WiGig) standard, Worldwide Interoperability for Microwave Access (WiMAX), mmWave standards in general (e.g., wireless systems operating at 10-300 GHz and above such as WiGig, IEEE 802.11ad, IEEE 802.1lay, etc.), V2X communication technologies (including 3GPP C-V2X), Dedicated Short Range Communications (DSRC) communication systems such as Intelligent-Transport-Systems (ITS) including the European ITS-G5, ITS-GSB, ITS-GSC, etc. In addition to the standards listed above, any number of satellite uplink technologies may be used for purposes of the present disclosure including, for example, radios compliant with standards issued by the International Telecommunication Union (ITU), or the European Telecommunications Standards Institute (ETSI), among others. The examples provided herein are thus understood as being applicable to various other communication technologies, both existing and not yet formulated.

The term “access network” refers to any network, using any combination of radio technologies, RATs, and/or communication protocols, used to connect user devices and service providers. In the context of WLANs, an “access network” is an IEEE 802 local area network (LAN) or metropolitan area network (MAN) between terminals and access routers connecting to provider services. The term “access router” refers to router that terminates a medium access control (MAC) service from terminals and forwards user traffic to information servers according to Internet Protocol (IP) addresses.

The terms “instantiate,” “instantiation,” and the like as used herein refers to the creation of an instance. An “instance” also refers to a concrete occurrence of an object, which may occur, for example, during execution of program code. The term “information element” refers to a structural element containing one or more fields. The term “field” refers to individual contents of an information element, or a data element that contains content. As used herein, a “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like.

The foregoing description provides illustration and description of various example embodiments, but is not intended to be exhaustive or to limit the scope of embodiments to the precise forms disclosed. Modifications and variations are possible in light of the above teachings or may be acquired from practice of various embodiments. Where specific details are set forth in order to describe example embodiments of the disclosure, it should be apparent to one skilled in the art that the disclosure can be practiced without, or with variation of, these specific details. It should be understood, however, that there is no intent to limit the concepts of the present disclosure to the particular forms disclosed, but on the contrary, the intention is to cover all modifications, equivalents, and alternatives consistent with the present disclosure and the appended claims.

1. An apparatus to be employed as a user equipment (UE), the apparatus comprising:
processor circuitry configurable to generate a message to establish a connection with an onboarding server for obtaining Non-Public Network (NPN) credentials, the message to include default credentials configured in the UE by a device manufacturer; and
radiofrequency (RF) circuitry communicatively coupled with the processor circuitry, the RF circuitry operable to transmit the message to an onboarding server, and receive the NPN credentials from the onboarding server based on the default credentials.

2. The apparatus of claim 1, wherein the default credentials include default UE credentials for UE authentication and a unique UE identifier.

3. The apparatus of claim 2, wherein the default credentials comprise a subscriber identifier (SUPI) that is a combination of a Public Land Mobile Network (PLMN) identifier (ID) and Network identifier (MD).

4. The apparatus of claim 2, wherein the default credentials comprise a SUPI containing a network-specific identifier that takes the form of a Network Access Identifier (NAI) or a SUPI containing an international mobile subscriber identity (IMSI).

5. The apparatus of claim 2, wherein the processor circuitry is configurable to:
discover and select a Standalone NPN (SNPN) according to broadcasted information and configured information in the UE.

6. The apparatus of claim 5, wherein the SNPN discovers and connects with a Default Credential Server (DCS) based on the unique UE identifier, and the SNPN authenticates the UE with the DCS to verify whether the UE is allowed to access the SNPN for onboarding purposes.

7. The apparatus of claim 6, wherein the connection to be established is a Configuration Protocol Data Unit (PDU) session, and the processor circuitry is further configurable to: establish the Configuration PDU session with the onboarding server.

8. The apparatus of claim 7, wherein the onboarding server selects a home network and provides the subscription credentials for access to the home network.

9. The apparatus of claim 7, wherein the RF circuitry is operable to: obtain the NPN credentials for the home network over a secure connection of the Configuration PDU session.

10. The apparatus of claim 7, wherein:
the processor circuitry is further configurable to generate a registration message to include the NPN credentials; and
the RF circuitry is further operable to transmit the registration message to the home network to initiate a registration procedure with the home network.

11. One or more non-transitory computer-readable media (NTCRM) comprising instructions, wherein execution of the instructions by one or more processors of an onboarding server is to cause the onboarding server to:
establish a connection with a user equipment (UE);
obtain UE default credentials for obtaining Non-Public Network (NPN) credentials over the connection; and
obtain the NPN credentials from a selected NPN based on the UE default credentials; and
provision the UE with the NPN credentials.

12. The one or more NTCRM of claim 11, wherein the established connection is a Configuration Protocol Data Unit (PDU) session.

13. The one or more NTCRM of claim 12, wherein execution of the instructions is to cause the onboarding server to:
provision the NPN credentials for the home network over a secure connection of the Configuration PDU session.

14. The one or more NTCRM of claim 11, wherein the UE default credentials include a unique UE identifier.

15. The one or more NTCRM of claim 11, wherein the UE default credentials comprise a subscriber identifier (SUPI) that is a combination of a Public Land Mobile Network (PLMN) identifier (ID) and Network identifier (NID).

16. The one or more NTCRM of claim 14, wherein the UE default credentials comprise a SUPI containing a network-specific identifier that takes the form of a Network Access Identifier (NAI) or a SUPI containing an international mobile subscriber identity (IMSI).

17. The one or more NTCRM of claim 14, wherein execution of the instructions is to cause the onboarding server to:
discover and connect with a Default Credential Server (DCS) based on the unique UE identifier; and
obtain an indication from the DCS indicating whether the UE is allowed to access the NPN or the onboarding server for onboarding purposes.

18. The one or more NTCRM of claim 14, wherein execution of the instructions is to cause the onboarding server to:
compare the unique UE identifier with a configured onboarding list; and
select the NPN based on the comparison.

19. The one or more NTCRM of claim 11, wherein execution of the instructions is to cause the onboarding server to:
obtain an NPN identity from the UE; and
select the NPN using the obtained NPN identity.

20. The one or more NTCRM of claim 11, wherein execution of the instructions is to cause the onboarding server to:
generate the NPN credentials;
push the NPN credentials to the selected NPN.
